(19) United States
(12) Patent Application Publication
(10) Pub. No.: US 2024/0322447 A1
(43) Pub. Date: Sep. 26, 2024

(54) SIGNAL SENDING METHOD AND APPARATUS

(71) Applicant: HUAWEI TECHNOLOGIES CO., LTD., Shenzhen (CN)

(72) Inventor: Xianfeng Du, Chengdu (CN)

(73) Assignee: HUAWEI TECHNOLOGIES CO., LTD., Shenzhen (CN)

(21) Appl. No.: 18/731,357

(22) Filed: Jun. 3, 2024

Related U.S. Application Data
(63) Continuation of application No. PCT/CN2022/135931, filed on Dec. 1, 2022.

(30) Foreign Application Priority Data
Dec. 2, 2021 (CN) 202111467841.X

(51) Int. Cl. H01Q 21/06; H01Q 1/24; H01Q 21/00

(52) U.S. Cl. CPC H01Q 21/061; H01Q 1/246; H01Q 21/0025

(57) ABSTRACT

A method includes: A transmitting end obtains at least two first signals through a first channel. The transmitting end sends the at least two first signals to at least two receiving ends based on a first antenna array. One receiving end corresponds to one first signal. Sub-bands corresponding to all of the at least two first signals are different. One receiving end corresponds to one beam. Directions of beams corresponding to all of the at least two receiving ends are different. The beam is formed by the first antenna array.

### CROSS-REFERENCE TO RELATED APPLICATIONS

This is a continuation of International Application No. PCT/CN2022/135931, filed on Dec. 1, 2022, which claims priority to Chinese Patent Application No. 202111467841.X, filed on Dec. 2, 2021. The disclosures of the aforementioned applications are hereby incorporated by reference in their entireties.

### TECHNICAL FIELD

This disclosure relates to the field of communication technologies, and in particular, to a signal sending method and an apparatus.

### BACKGROUND

In a future communication system, millimeter-wave communication or terahertz communication is expected to meet a growing requirement on a wireless rate due to abundant frequency band resources of the millimeter-wave communication or terahertz communication, and therefore becomes a research and development hotspot in the industry. Although the millimeter-wave communication or terahertz communication may use a large quantity of radio frequency bands, a high-frequency carrier may also cause greater radio propagation attenuation (including free attenuation, a molecular absorption loss, and the like of electromagnetic energy), and consequently limits a propagation distance and reduces spectral efficiency.

To reduce a propagation loss existing in high-frequency communication, a communication system usually needs to be equipped with an antenna array to provide an energy gain.

Therefore, how to effectively use the antenna array to send a signal needs to be urgently resolved.

### SUMMARY

This disclosure provides a signal sending method and an apparatus, so that utilization efficiency of frequency domain resources can be effectively improved when a signal is sent by using an antenna array.

According to a first aspect, an embodiment of this disclosure provides a signal sending method, where the method includes:

A transmitting end obtains at least two first signals through a first channel. The transmitting end sends the at least two first signals to at least two receiving ends based on a first antenna array. One receiving end corresponds to one first signal. Sub-bands corresponding to all of the at least two first signals are different. One receiving end corresponds to one beam. Directions of beams corresponding to all of the at least two receiving ends are different. The beam is formed by the first antenna array.

In the method shown in this embodiment of this disclosure, the transmitting end may respectively send the first signals to the at least two receiving ends based on one antenna array (for example, the first antenna array). In other words, the transmitting end may send the first signals to receiving ends in coverage areas of at least two beams based on the first antenna array. Therefore, utilization efficiency of frequency domain resources is effectively improved.

In an example implementation, the at least two receiving ends include a first receiving end. That the transmitting end sends the at least two first signals to at least two receiving ends based on a first antenna array includes: The transmitting end sends, to the first receiving end by using at least two antenna arrays, at least two signals corresponding to the first receiving end. The at least two antenna arrays include the first antenna array. The at least two signals corresponding to the first receiving end include the first signal. The at least two signals corresponding to the first receiving end correspond to different sub-bands respectively.

One receiving end can also be simultaneously served by beams corresponding to at least two sub-bands. Therefore, the receiving end implements large-bandwidth communication, and a communication capacity of a system is also improved. It may be understood that for descriptions provided in this embodiment of this disclosure, refer to descriptions in FIG. 5 to FIG. 11.

In an example implementation, the at least two antenna arrays further include a second antenna array. A direction of an i^{th} beam formed by the first antenna array is the same as a direction of an i^{th} beam formed by the second antenna array. i is an integer greater than or equal to 1 and less than or equal to L. L is a quantity of beams formed by the first antenna array or a quantity of beams formed by the second antenna array.

In an example implementation, a sub-band corresponding to the i^{th} beam formed by the first antenna array is different from a sub-band corresponding to the i^{th} beam formed by the second antenna array.

In an example implementation, the at least two antenna arrays further include the second antenna array. The direction of the i^{th} beam formed by the first antenna array is different from the direction of the i^{th} beam formed by the second antenna array. i is an integer greater than or equal to 1 and less than or equal to L. L is the quantity of beams formed by the first antenna array or the quantity of beams formed by the second antenna array.

In an example implementation, a bandwidth scheduled by the first antenna array is the same as a bandwidth scheduled by the second antenna array. Alternatively, a bandwidth scheduled by the first antenna array is different from a bandwidth scheduled by the second antenna array. Alternatively, a bandwidth scheduled by the first antenna array partially overlaps a bandwidth scheduled by the second antenna array.

In an example implementation, the method further includes: The transmitting end determines the at least two receiving ends based on the directions of the beams formed by the first antenna array.

In an example implementation, the method further includes: The transmitting end determines the directions of the beams of the first antenna array based on regions in which the at least two receiving ends are located.

In an example implementation, a bandwidth scheduled by the transmitting end is greater than or equal to a first threshold.

In an example implementation, a size of a sub-band scheduled by the first antenna array is less than or equal to a second threshold.

In an example implementation, the at least two receiving ends include a second receiving end. That the transmitting end sends the at least two first signals to at least two receiving ends based on a first antenna array includes: The transmitting end sends the first signals to the second receiving end by using the first antenna array. Alternatively, the transmitting end sends, to the second receiving end by using at least two antenna arrays, at least two signals corresponding to the second receiving end. The at least two antenna arrays include the first antenna array. The at least two signals corresponding to the second receiving end include the first signal. The at least two signals corresponding to the second receiving end correspond to different sub-bands respectively.

It may be understood that the at least two antenna arrays used to send the signals to the second receiving end may be the same as or different from the at least two antenna arrays used to send the signals to the first receiving end.

According to a second aspect, an embodiment of this disclosure provides a signal sending method. The method includes:

A transmitting end obtains at least two signals through at least two channels. One channel corresponds to one signal. The transmitting end sends the at least two signals to a first receiving end based on at least two antenna arrays. One signal corresponds to one antenna array, and sub-bands corresponding to all of the at least two signals are different. The first receiving end corresponds to at least two beams, and directions of all of the at least two beams are different.

In an example implementation, the at least two antenna arrays include a first antenna array and a second antenna array.

It may be understood that for descriptions of the second aspect, refer to descriptions of the first receiving end in the first aspect. Details are not described herein again. Alternatively, for the method provided in this embodiment of this disclosure, refer to the following description of FIG. 6a.

According to a third aspect, an embodiment of this disclosure provides a communication apparatus. The apparatus is configured to implement the method according to any one of the first aspect, the second aspect, or the example implementations. The communication apparatus includes a unit for performing the method according to any one of the first aspect or the example implementations of the first aspect.

According to a fourth aspect, an embodiment of this disclosure provides a communication apparatus. The communication apparatus includes a processor. The processor is configured to perform the method according to any one of the first aspect or the example implementations of the first aspect. Alternatively, the processor is configured to execute a program stored in a memory. When the program is executed, the method according to any one of the first aspect, the second aspect, or the example implementations.

In an example implementation, the memory is located outside the communication apparatus.

In an example implementation, the memory is located inside the communication apparatus.

In this embodiment of this disclosure, the processor and the memory may alternatively be integrated into one device. In other words, the processor and the memory may alternatively be integrated together.

In an example implementation, the communication apparatus further includes a transceiver. The transceiver is configured to receive a signal or send a signal.

According to a fifth aspect, an embodiment of this disclosure provides a communication apparatus. The communication apparatus includes a logic circuit and an interface. The logic circuit is coupled to the interface. The logic circuit is configured to obtain at least two first signals through a first channel. The interface is configured to output the at least two first signals.

Alternatively, the logic circuit is configured to obtain at least two signals through at least two channels. The interface is configured to output the at least two signals.

According to a sixth aspect, an embodiment of this disclosure provides a computer-readable storage medium. The computer-readable storage medium is configured to store a computer program. When the computer program is run on a computer, the method according to any one of the first aspect, the second aspect, or the example implementations is performed.

According to a seventh aspect, an embodiment of this disclosure provides a computer program product. The computer program product includes a computer program or computer code. When the computer program product is run on a computer, the method according to any one of the first aspect, the second aspect, or the possible implementations is performed.

According to an eighth aspect, an embodiment of this disclosure provides a computer program. When the computer program is run on a computer, the method according to any one of the first aspect, the second aspect, or the example implementations is performed.

According to a ninth aspect, an embodiment of this disclosure provides a communication system. The communication system includes a transmitting end and a receiving end. The transmitting end is configured to perform the method according to any one of the first aspect, the second aspect, or the example implementations.

For technical effects achieved in the second aspect to the ninth aspect, refer to the technical effects of the first aspect or beneficial effects in the following method embodiments. Details are not described herein again.

### BRIEF DESCRIPTION OF DRAWINGS

FIG. 1 is a schematic of an architecture of a communication system according to an embodiment of this disclosure;

FIG. 2 is a schematic of a scenario of signal sending according to an embodiment of this disclosure;

FIG. 3 is a schematic of another scenario of signal sending according to an embodiment of this disclosure;

FIG. 4 is a schematic flowchart of a signal sending method according to an embodiment of this disclosure;

FIG. 5 is a schematic of a scenario of a signal sending method according to an embodiment of this disclosure;

FIG. 6a is a schematic flowchart of a signal sending method according to an embodiment of this disclosure;

FIG. 6b is a schematic of a scenario of a signal sending method according to an embodiment of this disclosure;

FIG. 7 to FIG. 11 each are a schematic of a scenario of a signal sending method according to an embodiment of this disclosure; and

FIG. 12 to FIG. 14 each are a schematic of a structure of a communication apparatus according to an embodiment of this disclosure.

### DESCRIPTION OF EMBODIMENTS

To make the objectives, technical solutions, and advantages of this disclosure clearer, the following further describes this disclosure with reference to the accompanying drawings.

In the specification, claims, and the accompanying drawings of this disclosure, terms such as “first” and “second” are only intended to distinguish between different objects but do not describe a particular order. In addition, terms “include”, “have”, or any other variant thereof are intended to cover a non-exclusive inclusion. For example, a process, a method, a system, a product, or a device that includes a series of steps or units is not limited to the listed steps or units, but optionally further includes an unlisted step or unit, or optionally further includes another step or unit inherent to the process, the method, the product, or the device.

An “embodiment” mentioned in this specification means that a particular feature, structure, or characteristic described with reference to this embodiment may be included in at least one embodiment of this disclosure. The phrase shown in various positions in this specification may not necessarily refer to a same embodiment, and is not an independent or optional embodiment exclusive from another embodiment. It is explicitly and implicitly understood by a person skilled in the art that embodiments described in this specification may be combined with another embodiment.

In this disclosure, “at least one (item)” means one or more, “a plurality of” means two or more, “at least two (items)” means two, three, or more, and “and/or” is used to describe an association relationship between associated objects and indicates that three relationships may exist. For example, “A and/or B” may indicate the following three cases: Only A exists, only B exists, and both A and B exist, where A and B may be singular or plural. The character “/” usually indicates an “or” relationship between the associated objects. “At least one of the following items (pieces)” or a similar expression means any combination of these items. For example, at least one item (piece) of a, b, or c may represent: a or b or c; a and b; a and c; b and c; or a, b, and c.

A method provided in this disclosure may be applied to various communication systems, for example, an internet of things (IoT) system, a narrowband internet of things (NB-IoT) system, a long term evolution (LTE) system, a 5^{th} generation (5G) communication system, and a new communication system (for example, 6G) emerging in future communication development. In addition, the method provided in this disclosure may be further applied to a wireless local area network (WLAN) system, for example, wireless fidelity (Wi-Fi).

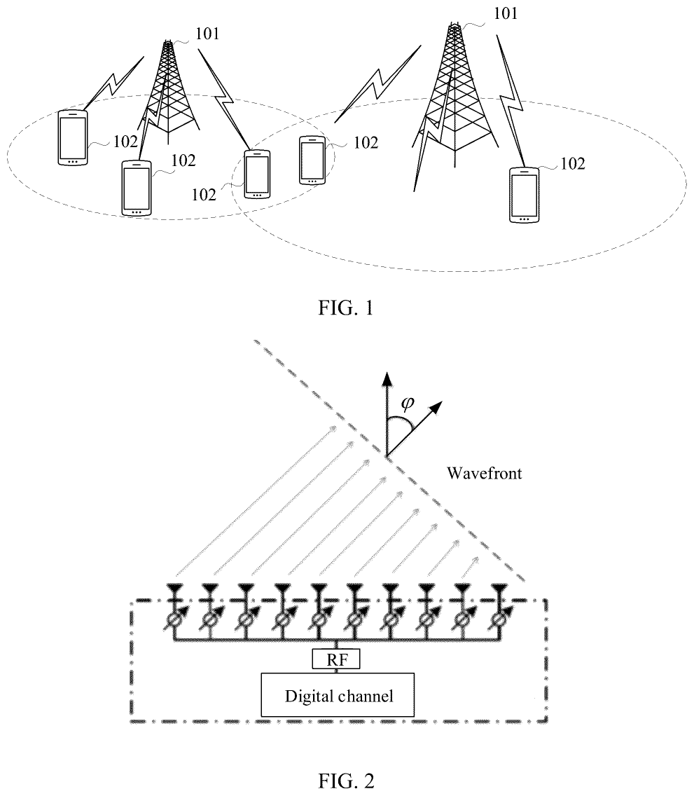

The technical solutions provided in this disclosure may be further applied to machine type communication (MTC), a machine-to-machine communication long term evolution technology (LTE-M), a device-to-device (D2D) network, a machine-to-machine (M2M) network, an internet of things (IoT) network, an industrial Internet, or another network. The IoT network may include, for example, the Internet of vehicles. Communication manners in an Internet of vehicles system are collectively referred to as vehicle-to-everything (V2X, where X may represent anything). For example, the V2X may include vehicle-to-vehicle (V2V) communication, vehicle-to-infrastructure (V2I) communication, vehicle-to-pedestrian (V2P) communication, or vehicle-to-network (V2N) communication, and the like. For example, in FIG. 1 shown in the following, a terminal device may communicate with another terminal device by using a D2D technology, an M2M technology, a V2X technology, or the like.

FIG. 1 is a schematic of an architecture of a communication system according to an embodiment of this disclosure. As shown in FIG. 1, the communication system includes a network device 101 and a terminal device 102.

For example, the network device may be a next generation NodeB (gNB), a next generation evolved base station (ng-eNB), a network device in 6G communication, or the like. The network device may be any device that has a wireless transceiver function, and includes but is not limited to the foregoing base station (including a base station deployed on a satellite). Alternatively, the base station may be a base station in a future communication system such as a sixth generation communication system. Optionally, the network device may be an access node, a wireless relay node, a wireless backhaul node, or the like in a wireless local area network (WLAN) system. Optionally, the network device may be a wireless controller in a cloud radio access network (CRAN) scenario. Optionally, the network device may be a wearable device, a vehicle-mounted device, or the like. Optionally, the network device may alternatively be a small cell, a transmission reception point (TRP) (or referred to as a transmission point), or the like. It may be understood that the network device may alternatively be a base station in a future evolved public land mobile network (PLMN), or the like.

In some deployments, the base station (for example, the gNB) may include a central unit (CU) and a distributed unit (DU). In other words, functions of the base station in an access network are split. Some functions of the base station are deployed on one CU, and remaining functions are deployed on the DU. In addition, a plurality of DUs share one CU, which can reduce costs and facilitate network expansion. In some other deployments of the base station, the CU may be further divided into a CU-control plane (CU-CP), a CU-user plane (CU-UP), and the like. In some other deployments of the base station, the base station may alternatively be an open radio access network (ORAN) architecture or the like. A specific type of the base station is not limited in this disclosure.

For example, the terminal device may also be referred to as a user equipment (UE), a terminal, or the like. The terminal device is a device having a wireless transceiver function, and may be deployed on land, including an indoor or outdoor device, a hand-held device, a wearable device, or a vehicle-mounted device, or may be deployed on water, for example, on a ship. The terminal device may be a mobile phone, a tablet computer (e.g. Pad), a computer with a wireless transceiver function, a virtual reality (VR) terminal device, an augmented reality (AR) terminal device, a wireless terminal in industrial control, a wireless terminal in self driving, a wireless terminal in telemedicine or telehealth services, a wireless terminal in a smart grid, a wireless terminal in transportation safety, a wireless terminal in a smart city, a wireless terminal in a smart home, or the like. It may be understood that the terminal device may alternatively be a terminal device in a future 6G network, a terminal device in a future evolved PLMN, or the like.

It may be understood that the terminal device shown in this disclosure may include a vehicle (for example, an automobile) in the Internet of vehicles, and may also include a vehicle-mounted device, a vehicle-mounted terminal, or the like in the Internet of vehicles. A specific form of the terminal device when the terminal device is used in the Internet of vehicles is not limited in this disclosure. A quantity of network devices and a quantity of terminal devices shown in FIG. 1 are merely examples, and shall not be understood as a limitation on embodiments of this disclosure.

Network architectures and service scenarios described in embodiments of this disclosure are intended to more clearly describe technical solutions in embodiments of this disclosure, but are not intended to limit the technical solutions provided in embodiments of this disclosure. A person of ordinary skill in the art may know that as the network architectures evolve and a new service scenario emerges, the technical solutions provided in embodiments of this disclosure are also applicable to a similar technical problem.

The following describes in detail terms related to this disclosure.

Beam squint: The beam squint is a phenomenon that signal energy cannot be fully focused within a frequency band range when an antenna array implements beam steering by using a phase shifter. For example, if it is expected that the signal energy sent by using the antenna array is focused in a direction, the phase shifter may be used to set specific phase compensation. However, such phase compensation is usually for only one frequency (for example, a carrier center frequency), so that the signal energy is superposed in a specified direction. For a signal that is not at the frequency, a direction of energy superposition is not the specified direction, but has a specific deviation. This is referred to as the beam squint. The beam squint causes signals of different frequency components to converge in different directions.

Digital channel: The digital channel is a channel from a baseband digital port to a radio frequency (RF) link. For example, the digital channel is a channel through which a data stream (which may also be referred to as a baseband signal) obtained through baseband processing arrives at an RF. For example, the data stream obtained through baseband processing may be converted into, through the digital channel, an analog signal by using a digital-to-analog converter (DAC). For example, the digital channel may be used to transmit the data stream. A data stream transmitted on one digital channel may include signals corresponding to a plurality of sub-bands. The signals corresponding to the plurality of sub-bands carry data corresponding to a plurality of receiving ends, and a signal corresponding to one sub-band carries data corresponding to one receiving end. In embodiments of this disclosure, a transmitting end may include one or more digital channels. When the transmitting end includes a plurality of digital channels, the plurality of digital channels may simultaneously transmit a plurality of data streams, to improve a throughput of a system. For example, the plurality of data streams may be isolated by using one or more of time division multiplexing, frequency division multiplexing, or spatial division multiplexing, to ensure that the transmitting end can transmit the plurality of data streams by using the plurality of digital channels.

Antenna array: An antenna corresponding to a digital channel may be referred to as an antenna array. In the method shown in this disclosure, the transmitting end may include one or more antenna arrays. For example, one antenna array may include a plurality of antenna array elements. The antenna array element may also be referred to as an antenna unit, an antenna element, or the like. A specific name of the antenna array element is not limited in embodiments of this disclosure. It may be understood that the antenna array shown in embodiments of this disclosure may also be briefly referred to as an array.

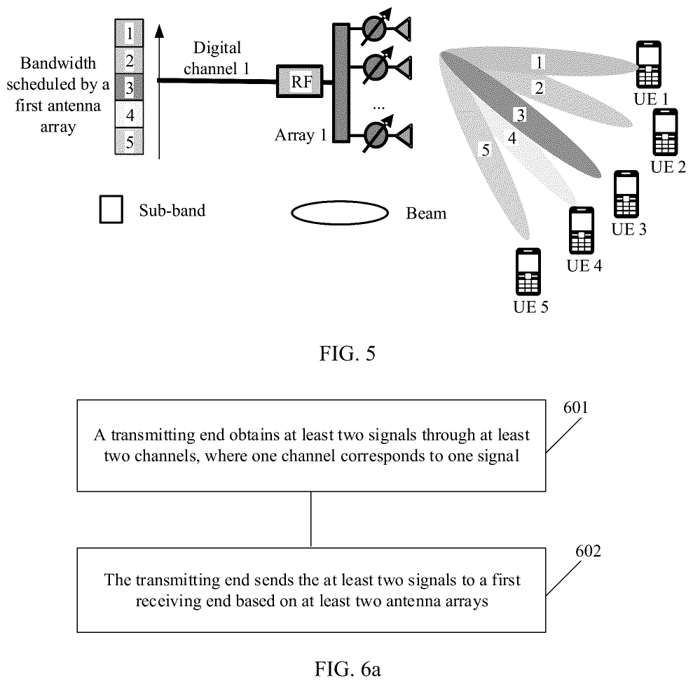

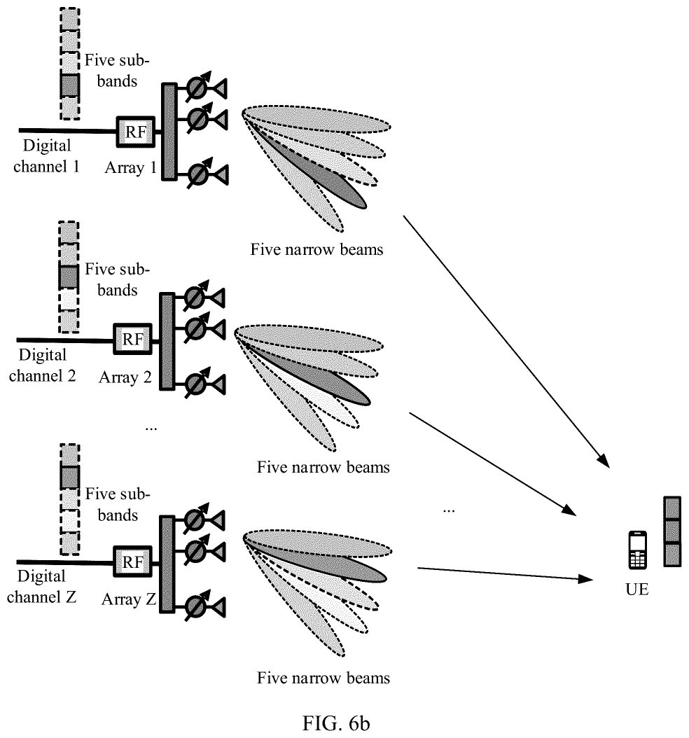

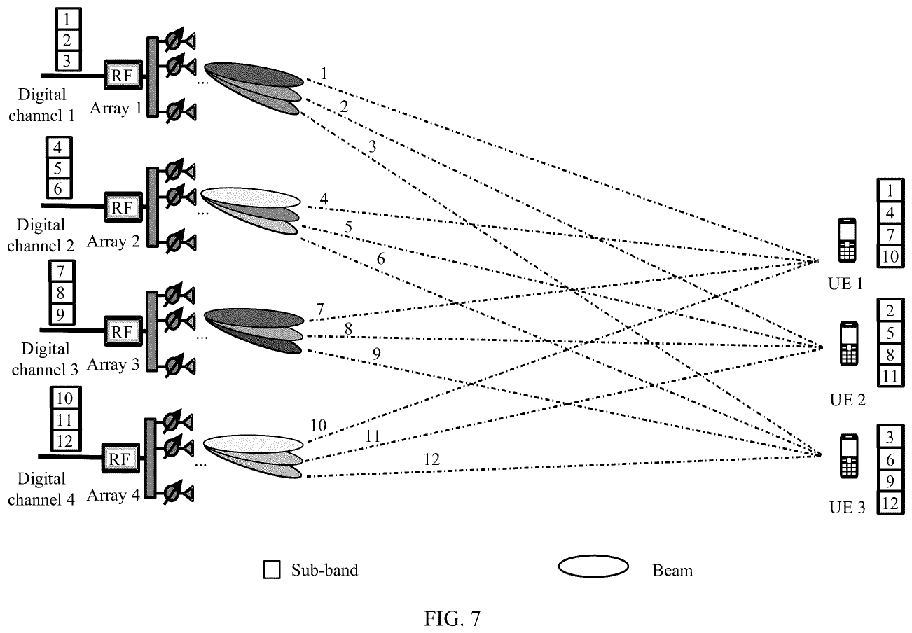

Phase shifter: One or more antenna array elements in an antenna array may correspond to one phase shifter. For example, a phase shift parameter of the phase shifter is used to configure the phase shifter. For example, changing the phase shift parameter of the phase shifter can adjust a direction of a beam. It may be understood that a manner of adjusting an amplitude and/or a phase of each antenna array element in the antenna array is not limited in embodiments of this disclosure. It may be understood that in embodiments of this disclosure, FIG. 5, FIG. 6a, and FIG. 7 to FIG. 11 are shown by using an example in which one phase shifter corresponds to one antenna array element. However, this shall not be construed as a limitation on embodiments of this disclosure.

Sub-band: A transmitting end may divide a bandwidth scheduled by an antenna array into a plurality of sub-bands. In other words, the sub-band may be understood as a part of a continuous bandwidth in an available bandwidth of the antenna array, or may be understood as a sub-bandwidth, a frequency sub-band, or the like. In the method shown in this disclosure, a bandwidth occupied when one antenna array sends a signal is referred to as a bandwidth scheduled by the antenna array, or is referred to as a bandwidth used by the antenna array. For example, a bandwidth used when the transmitting end sends a first signal is referred to as a bandwidth scheduled by a first antenna array used to send the first signal. It may be understood that different sub-bands shown in embodiments of this disclosure may be understood as different frequency domain resources.

Direction of a beam: Changing a phase shift parameter of a phase shifter can adjust a direction of a beam. It should be noted that the direction of the beam shown in embodiments of this disclosure may represent a direction of a center frequency of a sub-band corresponding to the beam. For example, that directions of beams corresponding to all of at least two receiving ends are different in embodiments of this disclosure may be understood as that directions of center frequencies of sub-bands corresponding to all the receiving ends are different, or pointing directions of center frequencies of sub-bands corresponding to all the receiving ends are different. Similarly, that coverage areas of beams are different in embodiments of this disclosure may also be understood as that center frequencies of sub-bands corresponding to the beams are different.

That directions of two beams (or more than two beams) are the same in embodiments of this disclosure means that coverage areas of the two beams are the same in a specific region, or the directions of the two beams are the same in a specific permissible error range. For example, that the directions of the two beams are the same means that 80% or more than 80% of the two beams overlap in a coverage area of a 3 dB beam width. For another example, that the directions of the two beams are the same means that 90% or more than 90% of the two beams overlap in the coverage area of the 3 dB beam width. For another example, for one receiving end, when a signal is sent to the receiving end by using beams corresponding to at least two antenna arrays, if a direction of an i^{th} beam formed by a first antenna array is the same as a direction of an i^{th} beam formed by a second antenna array, it means that the receiving end is within the coverage areas of the 3 dB beam widths of the two beams at the same time.

FIG. 2 is a schematic of a scenario of signal sending according to an embodiment of this disclosure. As shown in FIG. 2, it is assumed that a transmitting end is about to send a plane wave whose angle of departure is φ, and a spacing between antenna array elements is dₐ. In this case, a difference between distances between adjacent array elements and a wave plane is dₐ sin φ, and a phase difference satisfies Formula (1):

$$Δ θ = \frac{2 π {d}_{a} sin φ}{λ} = \frac{2 π {d}_{a} f sin φ}{c} \qquad ( 1 )$$

c represents a speed of light, f is a frequency of a sent signal, and λ is a wavelength of the signal.

For a signal with a small bandwidth, it may be considered that the frequency of the sent signal is a carrier frequency, that is, f=f_{c}. In this case, a phase shifter may be used to perform reverse compensation on a phase of the signal sent by an antenna based on Δθ, so that all signals are in a same phase when reaching the wave plane, to achieve a purpose of energy superposition.

However, in millimeter-wave communication or terahertz communication, because of a feature of low spectral efficiency but abundant spectrum resources of the millimeter-wave communication or terahertz communication, a large-bandwidth signal usually needs to be transmitted to improve a communication rate. It is assumed that B is the bandwidth of the signal, the frequency of the sent signal satisfies Formula (2):

$$f ∈ [ {f}_{c} - \frac{B}{2} , {f}_{c} + \frac{B}{2} ] \qquad ( 2 )$$

In this case, if each antenna array element sends the signal whose frequency is f, a phase change in a direction of the angle of departure φ may be represented by a normalized vector, and the normalized vector satisfies Formula (3):

$$a ( φ , f ) = {\frac{1}{\sqrt{N}} [ 1 , {e}^{- j \frac{2 π f {d}_{a} sin φ}{c}} , … , {e}^{- j \frac{( N - 1 ) 2 π {fd}_{a} sin φ}{c}} ]}^{T} \qquad ( 3 )$$

N is a quantity of antenna array elements. For meanings of other parameters, refer to the foregoing description.

It can be learned from the foregoing formula that, the phase change of the signal sent by each antenna array element in the direction of the angle of departure φ is related to the frequency f. However, the phase shifter used for compensation is usually considered to respond without frequency selectivity (for example, the phase shifter compensates a same phase for signals at all frequencies). During actual disclosure, phase compensation is usually set based on a carrier center frequency, to offset the phase change of each signal in the direction of the angle of departure φ. Such a vector with a normalized phase shift parameter may satisfy the following formula:

$$ω ( φ , {f}_{c} ) = {\frac{1}{\sqrt{N}} [ 1 , {e}^{- j \frac{2 π {f}_{c} {d}_{a} sin φ}{c}} , … , {e}^{- j \frac{( N - 1 ) 2 π {f}_{c} {d}_{a} sin φ}{c}} ]}^{T} \qquad ( 4 )$$

For meanings of parameters, refer to the foregoing descriptions. Details are not described herein again.

With the phase shifter, a normalized energy gain (which may also be referred to as a beam gain, a power gain, or the like) of the signal whose frequency is f in the direction of the angle of departure φ may satisfy the following formula:

$${A}_{f} ( φ , f ) = {\vert {ω ( φ , {f}_{c} )}^{H} a ( φ , f ) \vert}^{2} = {\vert \frac{1}{N} {\sum }_{n = 1}^{N} {e}^{- j ( \frac{2 π {f}_{c} {d}_{a} ( n - 1 )}{c} ) ( \frac{f}{{f}_{c}} sin φ - sin φ )} \vert}^{2} \qquad ( 5 )$$

It may be understood that Formula (2) to Formula (5) in this embodiment of this disclosure are merely examples, and shall not be construed as a limitation on embodiments of this disclosure.

It can be learned from Formula (5) that, a value of A_{f}(φ, f) is the largest when

$$\vert \frac{f}{{f}_{c}} sin φ - sin φ \vert = 0 ,$$

and decreases as

$$\vert \frac{f}{{f}_{c}} sin φ - sin φ \vert$$

increases. It may be analyzed that:
(1) When φ=0, for a signal at any f, the energy gain may reach a maximum, that is, A_{f}(φ,f)=1.
(2) When φ≠0, a beam energy gain of a signal component may reach a maximum when f=f_{c}. For a signal component existing when f≠f_{c} a larger deviation of f from f_{c} indicates a smaller energy gain. In addition, a closer distance the angle of departure φ∈[−90°,90°] of a beam has to ±90° indicates a clearer decrease in the gain of the signal component existing when f≠f_{c}. A larger quantity of antenna array elements N indicates a clearer decrease in the gain of the signal component existing when f≠f_{c}.

Therefore, if a large-scale phased array is used to implement the energy gain in a direction existing when φ≠0, a gain of a signal at a

$$f = {f}_{c} \pm \frac{B}{2}$$

component gradually decreases as B increases. As a result, an effective frequency bandwidth resource B in a specific direction is limited.

In addition, if an antenna array whose phase control coefficient is ω(φ, f_{c}) is used, only the signal component existing when f=f_{c} can generate a maximum energy gain in the direction of φ, and an energy gain that is of the signal component existing when f≠f_{c} and that is in the direction of φ decreases. This is because the antenna array whose phase control coefficient is ω(φ, f_{c}) focuses the signal existing when f≠f_{c} in a direction that deviates from φ. In other words, when a directional energy gain is implemented for the signal by using the phased array, signal components at different frequencies point to different directions (that is, a beam squint phenomenon).

In addition, a bandwidth scheduled by the antenna array may be divided into a plurality of sub-bands. Therefore, when the phase shift parameter is selected, energy of signals corresponding to all the sub-bands are propagated in different directions. It may also be understood that the signals corresponding to all the sub-bands correspond to beams in different directions (or may be understood that different sub-bands correspond to different narrow beams).

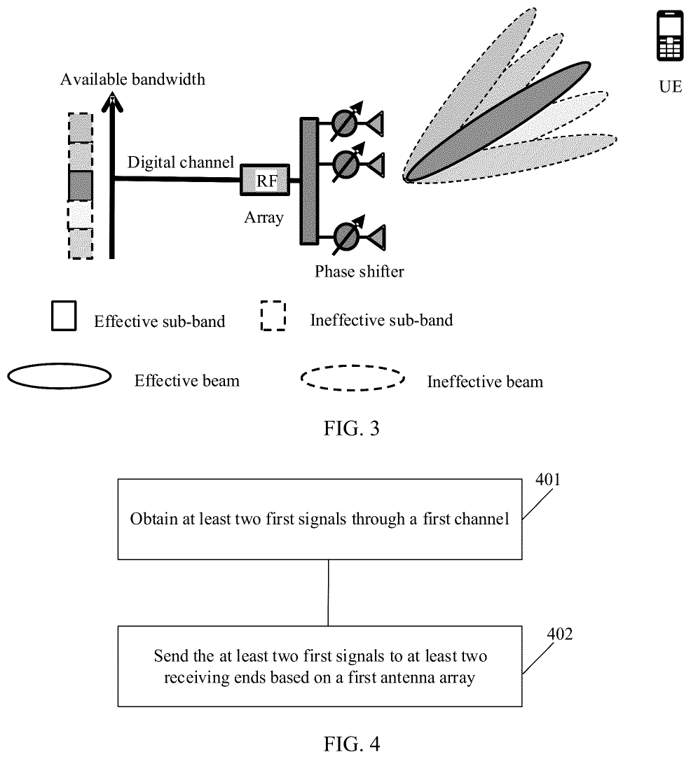

FIG. 3 is a schematic of another scenario of signal sending according to an embodiment of this disclosure. When a transmitting end needs to send a signal, a phase shift parameter may be set according to Formula (3) and/or Formula (4), so that a beam formed by an antenna array points to a UE. As shown in FIG. 3, after a beamformer and/or a phase shifter of the antenna array are/is set, energy that is of all sub-bands and that reaches a specific UE differs due to a beam squint phenomenon. A beam pointing to a direction of the UE (that is, a midmost beam in a solid line part in FIG. 3) can transmit maximum signal energy, and a sub-band corresponding to the beam is scheduled to serve the UE. For other sub-bands (for example, beams in dashed line parts in FIG. 3), because signal energy that can be transmitted by the corresponding beams is excessively small, these spectrum resources cannot be effectively used.

That is, in a signal sending method shown in FIG. 3, when the signal is sent by using the antenna array, only a beam corresponding to a part of sub-bands can be effectively used (namely, an effective beam), and other sub-bands may be considered as ineffective beams. Alternatively, it may be understood that when the signal is sent by using the antenna array, only one type of UE (that is, a UE within a coverage area of the beam in the solid line part in FIG. 3) can be served. In addition, in the method shown in FIG. 3, a bandwidth configured for the UE is usually small. Therefore, it can be learned from Formula (5) that when the bandwidth configured for the UE is small, impact of the beam squint may be ignored.

However, as a system bandwidth gradually increases (for example, with development of a communication system, the system bandwidth gradually increases), if the method shown in FIG. 3 is still used to send the signal, the UE can use only a part of the bandwidth, and consequently, the UE cannot implement large-bandwidth communication. Especially in a millimeter-wave communication scenario and/or a terahertz communication scenario, because of abundant frequency band resources of millimeter-wave communication and/or terahertz communication, the system bandwidth is large, and a large bandwidth needs to be configured for the UE, so that the UE can effectively use large-bandwidth communication. However, in the method shown in FIG. 3, there are a large quantity of ineffective beams, and consequently, most frequency domain resources are wasted. Optionally, the method shown in FIG. 3 further causes the UE to be unable to effectively use large-bandwidth communication.

In view of this, an embodiment of this disclosure provides a first signal sending method and an apparatus. When a signal is sent by using an antenna array, a bandwidth that can be scheduled by the antenna array can be effectively used, so that beams corresponding to at least two sub-bands of the bandwidth scheduled by the antenna array are effectively used, to serve receiving ends in at least two different coverage areas, and improve utilization efficiency of frequency domain resources. Optionally, a transmitting end may respectively send signals to one receiving end by using a plurality of antenna arrays. Optionally, a transmitting end may respectively send signals to a plurality of receiving ends by using a plurality of antenna arrays. Optionally, a transmitting end may respectively send first signals to a plurality of receiving ends by using one antenna array such as a first antenna array. The method provided in embodiments of this disclosure may be any one of the foregoing methods, or may be a combination of the foregoing methods, or the like. Optionally, in this embodiment of this disclosure, one receiving end can be simultaneously served by the beams corresponding to the at least two sub-bands. Therefore, the receiving end implements large-bandwidth communication (for example, in comparison with the method shown in FIG. 3, an available bandwidth for the receiving end is increased), and a channel capacity of the receiving end is improved.

It may be understood that the transmitting end shown in this embodiment of this disclosure may include the network device shown in FIG. 1, and the receiving end may include the terminal device shown in FIG. 1. Alternatively, the transmitting end may include the terminal device. Alternatively, the transmitting end and the receiving end each may be the terminal device shown in FIG. 1, and the transmitting end is a terminal device that has a network function in V2X. For example, the transmitting end may be a base station configured with a large-scale antenna array. The large-scale antenna array may be understood as an antenna array having a large quantity of antenna array elements. For example, when a quantity of antenna array elements in an antenna array is greater than or equal to 128, or is greater than or equal to 256, or the like, the antenna array may be referred to as a large-scale antenna array. It may be understood that the description of the large-scale antenna array shown in this embodiment of this disclosure is merely an example, and shall not be construed as a limitation on embodiments of this disclosure.

FIG. 4 is a schematic flowchart of a signal sending method according to an embodiment of this disclosure. As shown in FIG. 4, the method includes the following steps.

401: A transmitting end obtains at least two first signals through a first channel.

The first channel may include a digital channel. For a description of the digital channel, refer to the foregoing description. Details are not described herein again. It may be understood that the digital channel may also be referred to as a data channel. A name of the first channel is not limited in embodiments of this disclosure. It may be understood that the first channel shown herein may be understood as a digital channel or a data channel. For example, the transmitting end obtains the at least two first signals through a digital channel. For example, the transmitting end may perform time domain resource mapping and/or frequency domain resource mapping based on time-frequency resources of different receiving ends, to obtain the at least two signals.

The first signal may be understood as a signal sent by using a first antenna array. In other words, each signal sent by using the first antenna array may be referred to as a first signal. When the first antenna array simultaneously sends at least two first signals, the at least two first signals may be first signals of at least two receiving ends. In other words, although each signal sent by using the first antenna array is referred to as a first signal, first signals sent to different receiving ends may be different. It should be noted that “simultaneously” shown herein may be understood as that the signals obtained by the transmitting end are obtained through one digital channel.

It should be noted that the different receiving ends shown in this embodiment of this disclosure are respectively located in coverage areas of different beams. In other words, a difference between the different receiving ends shown in this embodiment of this disclosure lies in that the different receiving ends are located in coverage areas of different beams, or pointing directions of beams corresponding to the different receiving ends are different, or directions of beams corresponding to the different receiving ends are different. For example, a UE 1 to a UE 5 shown in FIG. 5 are respectively located in coverage areas of different beams. A quantity of receiving ends included in a coverage area of one beam is not limited in embodiments of this disclosure. A coverage area of a beam 1 shown in FIG. 5 may further include more UEs 1. In other words, in the accompanying drawings of this disclosure, an example in which the coverage area of one beam includes one UE is used for description, which shall not be construed as a limitation on embodiments of this disclosure.

402: The transmitting end sends the at least two first signals to the at least two receiving ends based on the first antenna array.

One receiving end corresponds to one first signal. Sub-bands corresponding to all of the at least two first signals are different. One receiving end corresponds to one beam. Directions of beams corresponding to all of the at least two receiving ends are different. The beam may be formed by the first antenna array. In other words, the first antenna array may form at least two beams. Each beam corresponds to a different sub-band. The first antenna array may send signals to receiving ends by using beams corresponding to different sub-bands.

For a relationship between the sub-band and the beam, refer to the foregoing descriptions of beam squint, the foregoing descriptions of FIG. 2 and FIG. 3, or the like. Details are not described herein again. For example, a quantity of beams formed by the first antenna array is the same as a quantity of sub-bands scheduled by the first antenna array. When the transmitting end sends the first signals to the receiving ends, correspondingly, the receiving ends receive the first signals.

It may be understood that a single beam formed by the first antenna array may also be referred to as a narrow beam. That directions of beams corresponding to all of the at least two receiving ends are different may also be understood as that pointing directions of the beams corresponding to all of the at least two receiving ends are different, or coverage areas of the beams corresponding to all of the at least two receiving ends are different.

In an example implementation, the transmitting end may determine the at least two receiving ends based on directions of the beams formed by the first antenna array, that is, determine receiving ends served by the first antenna array. In other words, after a phase shift parameter of the first antenna array is set, the first antenna array may determine, based on the directions of the beams and/or coverage areas of the beams, receiving ends that can receive first signals.

In another example implementation, the transmitting end may determine, based on a region in which a receiving end is located, a direction of a beam of the first antenna array, for example, a phase shift parameter of the first antenna array (which is merely an example, and may, for example, also be understood as determining a beamformer). For example, when the receiving end is determined, it indicates that a coverage area of the beam needs to cover the receiving end. Therefore, the transmitting end may determine the direction of the beam based on the region in which the receiving end is located, to determine the phase shift parameter and the like of a phase shifter. For another example, the transmitting end may schedule different sub-band resources to simultaneously serve receiving ends in different coverage areas. For another example, the transmitting end may adjust the direction of the beam by using a beamforming technology. A manner in which the transmitting end adjusts the pointing direction of the beam is not limited in embodiments of this disclosure. When a system bandwidth is large, due to impact of the beam squint, if one antenna array is still used to serve a receiving end in the coverage area of one beam, the bandwidth is wasted. Therefore, in this embodiment of this disclosure, the beam squint can be effectively used. For example, the phase shift parameter used when the first antenna array sends a signal is adjusted, so that different beams formed by the first antenna array can be effectively used, to serve receiving ends in coverage areas of the different beams.

It may be understood that the descriptions of the beam and the receiving end in this embodiment of this disclosure are also applicable to the following descriptions, for example, are also applicable to FIG. 6a and Embodiment 1 to Embodiment 4.

In this embodiment of this disclosure, a bandwidth scheduled by the transmitting end is greater than or equal to a first threshold. In addition, the bandwidth scheduled by the transmitting end is greater than or equal to a bandwidth configured for the receiving end. When the bandwidth scheduled by the transmitting end (that is, the available bandwidth shown above) is large, in this embodiment of this disclosure, the transmitting end can send first signals to receiving ends in different coverage areas, and also interference between the first signals can be avoided as much as possible because sub-bands corresponding to the receiving ends are different. For example, the transmitting end may set a size of the sub-band based on a coverage area of a beam formed by the transmitting end. For another example, the transmitting end may set a size of the sub-band based on isolation between beams formed by the transmitting end. For another example, the transmitting end may determine a size of the sub-band or the like based on the system bandwidth and a degree of the beam pointing squint. The size of the sub-band is not limited in embodiments of this disclosure. It may be understood that the bandwidth scheduled by the transmitting end in this embodiment of this disclosure may also be understood as the system bandwidth. The bandwidth configured for the receiving end represents a bandwidth configured by a network device for the receiving end, and may also, for example, be understood as a bandwidth that can be used by the receiving end.

In this embodiment of this disclosure, the size of the sub-band scheduled by the first antenna array is less than or equal to a second threshold, or the sub-band corresponding to the first signal cannot exceed a second threshold (for example, a bandwidth of the sub-band cannot exceed the second threshold). In other words, if the second threshold is excessively large, the receiving end cannot effectively use the sub-band corresponding to the first signal due to a beam squint phenomenon. For example, the second threshold may be determined based on the size of the sub-band of the first signal and/or an angle of departure of the first signal. For another example, the second threshold may be determined based on the size of the sub-band of the first signal, an angle of departure of the first signal, and a quantity of array elements of the first antenna array. For example, it is assumed that a center frequency of the sub-band is f_{c}, a vector of a phase shift coefficient of the phase shifter is ω(ω, f_{c}), and an energy concentration direction of the first signal is φ. In this case, an energy gain A_{f}(φ, f*) of a first signal component of a non-center frequency f* in the sub-band corresponding to the first signal in a direction φ may satisfy Formula (6):

$$\begin{matrix}{A}_{f} ( φ , {f}^{*} ) = {\vert {ω ( φ , {f}_{c} )}^{H} a ( φ , {f}^{*} ) \vert}^{2} = {\vert \frac{1}{N} {\sum }_{n 1}^{N} {e}^{- j ( \frac{2 π {f}^{*} {d}_{a} ( n - 1 ) sin φ}{c} \frac{2 π {f}_{c} {d}_{a} ( n - 1 ) sin φ}{c} )} \vert}^{2} = {\vert \frac{1}{N} {\sum }_{n = 1}^{N} {e}^{- j ( \frac{2 π {f}_{c} {d}_{a} ( n - 1 )}{c} ) ( \frac{{f}^{*}}{{f}_{c}} sin φ sin φ )} \vert}^{2} = {\vert \frac{1}{N} {e}^{- j ( \frac{π {f}_{c} {d}_{a} ( N - 1 )}{c} )} \frac{sin [ \frac{N π {f}_{c} {d}_{a}}{c} ( \frac{{f}^{*}}{{f}_{c}} sin φ - sin φ ) ]}{sin [ \frac{π {f}_{c} {d}_{a}}{c} ( \frac{{f}^{*}}{{f}_{c}} sin φ - sin φ ) ]} \vert}^{2} = {\vert \frac{sin [ \frac{N π {f}_{c} {d}_{a}}{c} ( \frac{{f}^{*}}{{f}_{c}} sin φ - sin φ ) ]}{N sin [ \frac{π {f}_{c} {d}_{a}}{c} ( \frac{{f}^{*}}{{f}_{c}} sin φ - sin φ ) ]} \vert}^{2} \\ \end{matrix} \qquad ( 6 )$$

ω(φ, f_{c})^{H} represents a transposition of the vector of the phase shift parameter. a(φ, f*) represents a phase change vector of each antenna array element in the energy concentration direction φ when the antenna array element sends a signal whose frequency is f*. N represents the quantity of antenna array elements of the first antenna array. dₐ represents a spacing between adjacent antenna array elements. φ represents the energy concentration direction of the first signal, or may represent the angle of departure of the first signal. f_{c} represents the center frequency of the sub-band of the first signal. f* represents the non-center frequency of the sub-band of the first signal. It may be understood that Formula (6) is merely an example, and shall not be construed as a limitation on embodiments of this disclosure.

It can be learned from Formula (6) that the foregoing function is an expression of a sine function, the function has a main lobe, and a peak value is obtained when f*=f_{c}. As f* deviates from f_{c}, energy gradually decreases. Energy at a first null position is reduced to 0. A frequency corresponding to the first null position satisfies Formula (7):

$$\frac{N π {f}_{c} {d}_{a}}{c} ( \frac{{f}^{*}}{{f}_{c}} sin φ - sin φ ) = \pm π ⇒ {f}^{*} = ( 1 \pm \frac{c}{N {f}_{c} {d}_{a} sin φ} ) {f}_{c} \qquad ( 7 )$$

It can be learned from Formula (7) that an upper threshold (that is, the second threshold) of the sub-band corresponding to the first signal needs to satisfy Formula (8):

$$Δ ( {f}_{c} ) = ( {f}_{c} + \frac{c}{N {d}_{a} sin φ} ) - ( {f}_{c} - \frac{c}{N {d}_{a} sin φ} ) = \frac{2 c}{N {d}_{a} sin φ} \qquad ( 8 )$$

If a half-wavelength array

$${d}_{a} = \frac{λ}{2}$$

is considered, the upper threshold (that is, the second threshold) may satisfy Formula (9):

$$Δ ( {f}_{c} ) = \frac{4 {f}_{c}}{N sin φ} \qquad ( 9 )$$

It may be understood that, for parameters involved in Formula (7) to Formula (9), refer to Formula (6).

It may be understood that the description of the sub-band of the first signal shown in this embodiment of this disclosure is also applicable to another signal. Details are not described in the following.

Optionally, the transmitting end may include a plurality of antenna arrays, and the plurality of antenna arrays include the first antenna array. Whether sizes of sub-bands obtained through division for each of the plurality of antenna arrays are the same is not limited in embodiments of this disclosure.

In comparison with FIG. 3 in which the transmitting end can send a signal to only one receiving end based on one antenna array, in other words, the transmitting end can send a signal to only the receiving end within the coverage area of one effective beam, in the method shown in this embodiment of this disclosure, the transmitting end may send first signals to at least two receiving ends based on one antenna array (for example, the first antenna array), in other words, the transmitting end may send first signals to receiving ends in coverage areas of at least two beams based on the first antenna array. Therefore, utilization efficiency of frequency domain resources is effectively improved.

In some embodiments of this disclosure, the transmitting end may include one antenna array, for example, the first antenna array. Therefore, the following uses the first antenna array as an example to describe the signal sending method provided in embodiments of this disclosure.

FIG. 5 is a schematic of a scenario of a signal sending method according to an embodiment of this disclosure. As shown in FIG. 5, leftmost numbers 1 to 5 represent sub-bands obtained through division for a first antenna array (for example, an array 1 shown in FIG. 5). Different numbers may represent different frequency domain resources corresponding to the sub-bands. An arrow from bottom to top represents a direction from a lowest frequency of a bandwidth to a highest frequency of the bandwidth. It can be learned from a beam squint phenomenon that, a higher frequency indicates that a beam corresponding to the frequency deviates more toward a normal direction of the antenna array. Therefore, because a center frequency of a sub-band 1, a center frequency of a sub-band 2, a center frequency of a sub-band 3, a center frequency of a sub-band 4, and a center frequency of a sub-band 5 are in descending order, directions of beams may be shown in FIG. 5, to be specific, a direction of a beam corresponding to the sub-band 1 deviates toward the normal direction of the antenna array, and a direction of a beam corresponding to the sub-band 2, a direction of a beam corresponding to the sub-band 3, a direction of a beam corresponding to the sub-band 4, and a direction of a beam corresponding to the sub-band 5 sequentially deviate from the normal direction of the antenna array. It may be understood that the descriptions of the sub-band and the direction of the beam are also applicable in the following descriptions.

It may be understood that specific values of sizes of the sub-bands represented by the number 1 to the number 5 are not limited in embodiments of this disclosure. For example, the sub-bands represented by the number 1 to the number 5 may be consecutive. Alternatively, a guard band or the like may be included between every two adjacent sub-bands. This is not limited in embodiments of this disclosure. The sub-band 1 scheduled by the first antenna array, a beam represented by a number 1, and a UE 1 correspond to each other. For example, the beam corresponding to the sub-band 1 is the beam 1, and a UE in a coverage area of the beam 1 includes the UE 1 (which may also be understood as that a direction of the beam 1 points to a region in which the UE 1 is located). The description of the number 1 is also applicable to the number 2 to the number 5, and details are not described herein again.

In this embodiment of this disclosure, because different sub-bands correspond to different directions of beams (which may also be referred to as pointing directions of beams), receiving ends in five different coverage areas may be served. For example, one sub-band may correspond to one beam, and frequency domain resources corresponding to the sub-bands are different. Therefore, when a transmitting end simultaneously sends first signals to the UE 1 to a UE 5, interference between the UE 1 to the UE 5 may be almost ignored. Signals are sent to receiving ends in at least two different coverage areas by using the first antenna array, in other words, utilization efficiency of the frequency domain resources is effectively improved in a manner of frequency division multiplexing.

It may be understood that FIG. 5 shows only five sub-bands as an example. A quantity of sub-bands obtained through division for the first antenna array is not limited in embodiments of this disclosure. It may be understood that the first antenna array shown in FIG. 5 may obtain five first signals through a digital channel 1, and then simultaneously send the five first signals. It may be understood that in FIG. 5, an example in which the transmitting end is a base station and the receiving end is a UE is used to describe the method provided in this embodiment of this disclosure. However, this shall not be construed as a limitation on embodiments of this disclosure.

In this embodiment of this disclosure, energy distributions of signals corresponding to different sub-bands may correspond to different beams. In other words, in the manner of frequency division multiplexing, a single antenna array may simultaneously serve a plurality of receiving ends, and the plurality of receiving ends (that is, receiving ends in a plurality of different coverage areas) may be enabled to implement narrowband communication.

In some other embodiments of this disclosure, the transmitting end may include at least two antenna arrays, and the at least two antenna arrays include the first antenna array. For example, signals may be sent to a first receiving end by using the at least two antenna arrays. Optionally, the transmitting end may further send signals to a second receiving end by using one of the at least two antenna arrays. Optionally, the transmitting end may further send signals to the second receiving end by using at least two antenna arrays. The at least two antenna arrays used to send the signals to the second receiving end may be the same as or different from the at least two antenna arrays used to send the signals to the first receiving end. This is not limited in embodiments of this disclosure. A difference shown herein may include a case in which the antenna arrays do not overlap at all, or include a case in which at least two antenna arrays overlap.

In an example implementation, the at least two receiving ends include the first receiving end. That the transmitting end sends the at least two first signals to the at least two receiving ends based on the first antenna array includes:
sending, to the first receiving end by using the at least two antenna arrays, at least two signals corresponding to the first receiving end, where the at least two antenna arrays include the first antenna array, the at least two signals corresponding to the first receiving end include the first signal, and the at least two signals corresponding to the first receiving end correspond to different sub-bands respectively.

In other words, the first receiving end may receive at least two signals, and the at least two signals are respectively sent by using the different sub-bands of different antenna arrays. For example, the transmitting end may send two signals to the first receiving end by using two antenna arrays, that is, one antenna array corresponds to one signal. For example, the transmitting end may simultaneously send the first signal and a second signal to the first receiving end by using the first antenna array and a second antenna array. The first signal is sent by the first antenna array by using a first sub-band, and the second signal is sent by the second antenna array by using a second sub-band. In addition, the first signal and the second signal are obtained through different digital channels. For another example, the transmitting end may send three signals to the first receiving end by using three antenna arrays. Details are not listed herein again.

It may be understood that the description of the first receiving end is also applicable to the second receiving end. For example, the transmitting end may send, to the second receiving end by using one or more antenna arrays, signals corresponding to the second receiving end. However, the antenna array used to send the signals to the first receiving end may be the same as the antenna array used to send the signals to the second receiving end, or may partially overlap, or may not overlap at all. This is not limited in embodiments of this disclosure.

It should be noted that the receiving end may not perceive whether the receiving end receives one signal or two signals. The receiving end receives only a signal sent by the transmitting end through spatial division multiplexing and/or frequency division multiplexing. It may be understood that frequency division multiplexing in this embodiment of this disclosure may be understood as simultaneously sending signals corresponding to different frequency domain resources, and spatial division multiplexing may be understood as simultaneously sending signals of a same frequency domain resource to the receiving end by using a plurality of antenna arrays. Certainly, spatial division multiplexing may alternatively be implemented in a dual-polarization manner.

The at least two antenna arrays shown in this embodiment of this disclosure may include all antenna arrays in the transmitting end, or may be some antenna arrays in the transmitting end. This is not limited in embodiments of this disclosure. In other words, a quantity of antenna arrays used by the transmitting end to serve one receiving end is not limited in embodiments of this disclosure. For example, the first receiving end is used as an example. The transmitting end may first serve the first receiving end by using one antenna array such as the first antenna array. If a bandwidth configured for the first receiving end is greater than a bandwidth that can be scheduled by the first antenna array, the transmitting end may serve the first receiving end by using a plurality of antenna arrays. For example, the transmitting end may further invoke the second antenna array to serve the first receiving end. For example, if the second transmit array does not serve another receiving end, the transmitting end may select a sub-band that is not used by the first receiving end, and set a beam weighted value to enable the selected sub-band to point to the first receiving end. If the second antenna array is already serving another receiving end (that is, a beamformer is determined), it may be determined whether a frequency band that can send, under the current beamformer, the bandwidth for the first receiving end exists in a configured bandwidth of a transmitter. If the frequency band that can send, under the current beamformer, the bandwidth for the first receiving end exists in the configured bandwidth of the transmitter, a signal having the configured bandwidth of the transmitter is sent to the first receiving end. If the frequency band that can send, under the current beamformer, the bandwidth for the first receiving end does not exist in the configured bandwidth of the transmitter, another antenna array is considered. It may be understood that the method for configuring the antenna array by the transmitting end for the receiving end shown herein is merely an example, and shall not be construed as a limitation on embodiments of this disclosure.

It may be understood that for specific descriptions of this embodiment of this disclosure, refer to Embodiment 1 to Embodiment 4 shown in the following. Details are not described herein again.

In still some embodiments of this disclosure, the transmitting end may further send signals to one receiving end by using at least two antenna arrays. FIG. 6a is a schematic flowchart of a signal sending method according to an embodiment of this disclosure. As shown in FIG. 6a, the method includes the following steps.

601: A transmitting end obtains at least two signals through at least two channels, where one channel corresponds to one signal.

602: The transmitting end sends the at least two signals to a first receiving end based on at least two antenna arrays.

One signal corresponds to one antenna array, and sub-bands corresponding to all of the at least two signals are different. The first receiving end corresponds to at least two beams, and directions of all of the at least two beams are different. Correspondingly, the first receiving end may receive the signal from the transmitting end.

In an example implementation, the at least two antenna arrays include a first antenna array and a second antenna array.

It may be understood that for a description of FIG. 6a, refer to the foregoing description of FIG. 4. Details are not described herein again. Alternatively, refer to FIG. 6b shown in the following.

FIG. 6b is a schematic of a scenario of another signal sending method according to an embodiment of this disclosure. As shown in FIG. 6b, a receiving end (a UE shown in FIG. 6b) may receive signals sent by Z antenna arrays. In addition, sub-bands scheduled by each of the Z antenna arrays are different from sub-bands scheduled by any other antenna array among the Z antenna arrays. However, directions of beams corresponding to the sub-bands scheduled by all the antenna arrays are the same. For example, each antenna array divides a bandwidth scheduled by the antenna array into five sub-bands. If each antenna array has one sub-band forming a beam that may point to the UE, the UE may receive signals from a maximum of Z beams. Therefore, because different beams correspond to different sub-bands, the UE effectively implements large-bandwidth communication, and effectively improves communication efficiency.

It may be understood that FIG. 6b shows only three antenna arrays as an example, that is, an antenna array and a beam formed by the antenna array are omitted with ellipsis.

It may be understood that for a specific description of FIG. 6b, refer to FIG. 7 to FIG. 10 shown in the following. Details are not described herein again.

For the foregoing embodiments, each antenna array (for example, including Z antenna arrays) may generate L beams (corresponding to L sub-bands) when transmitting a signal (which is merely an example, and for example, sub-bands obtained through division for different antenna arrays may be different). The L beams may correspond to L regions, and one beam corresponds to one region (which may also be understood as that one beam corresponds to a receiving end in one coverage area). In addition, that coverage areas of the L beams formed by one antenna array are different may also be understood as that directions of the L beams formed by one antenna array are different. Z is an integer greater than or equal to 2, and L is an integer greater than or equal to 2. For example, a transmitting end includes the Z antenna arrays, and the bandwidth scheduled by each antenna array may include the L sub-bands, that is, each antenna array may schedule the L sub-bands. In this case, a bandwidth used by one receiving end includes a maximum of a bandwidth corresponding to Z sub-bands, that is, the transmitting end may send beams in a maximum of Z directions to the receiving end, or it may be understood as that the receiving end may receive signals sent by a maximum of Z beams. It may be understood that all of the Z sub-bands corresponding to one receiving end are different.

Optionally, a direction of an i^{th} beam formed by a first antenna array is the same as a direction of an i^{th} beam formed by a second antenna array. i is an integer greater than or equal to 1 and less than or equal to L. It may be understood that, that directions of L beams formed by each antenna array are correspondingly the same as directions of L beams formed by any other antenna array may also be understood as that directions of corresponding beams in all the antenna arrays are the same, or directions of beams at corresponding positions in all the antenna arrays are the same, or the like. For example, the directions of the L beams formed by each antenna array are correspondingly the same as the directions of the L beams formed by any other antenna array.

In this embodiment of this disclosure, a sub-band corresponding to the i^{th} beam formed by the first antenna array is different from a sub-band corresponding to the i^{th} beam formed by the second antenna array. In other words, when the directions of the corresponding beams are the same, sub-bands corresponding to the corresponding beams are different. For the description, refer to Embodiment 1 and Embodiment 2 shown in the following. It may be understood that Embodiment 1 and Embodiment 2 are shown by using an example in which each antenna array forms a same quantity of beams, and shall not be construed as a limitation on embodiments of this disclosure.

Optionally, the direction of the i^{th} beam formed by the first antenna array is different from the direction of the i^{th} beam formed by the second antenna array. i is an integer greater than or equal to 1 and less than or equal to L. For example, the directions of the L beams formed by each antenna array are correspondingly different from the directions of the L beams formed by any other antenna array. For the description, refer to Embodiment 3 and Embodiment 4 shown in the following.

In this embodiment of this disclosure, when each antenna array is divided into the same quantity of sub-bands, that is, each antenna array forms the same quantity of beams, the directions of the corresponding beams may be the same or may be different. The corresponding beams are beams at a same position in at least two antenna arrays. That is, directions of a first beam in the first antenna array and a first beam in the second antenna array may be same or different.

It should be noted that the transmitting end may send first signals to a second receiving end by using the first antenna array, or the transmitting end may send, to the second receiving end by using at least two antenna arrays, signals corresponding to the second receiving end. The at least two antenna arrays include the first antenna array. At least two signals corresponding to the second receiving end include the first signal. The at least two signals corresponding to the second receiving end correspond to different sub-bands respectively. It may be understood that the at least two antenna arrays used to send the signals to the second receiving end may be the same as or different from at least two antenna arrays used to send signals to a first receiving end. Optionally, the at least two antenna arrays that send signals to the second receiving end further include the second antenna array and/or a third antenna array.

The following describes the method provided in embodiments of this disclosure with reference to specific embodiments.

### Embodiment 1

A bandwidth scheduled by a first antenna array is different from a bandwidth scheduled by a second antenna array.

Optionally, directions to which L beams formed by one of at least two antenna arrays point are correspondingly the same as directions to which L beams formed by any other antenna array among the at least two antenna arrays point. Optionally, directions to which/beams formed by each antenna array point are correspondingly the same as directions to which L beams formed by any other antenna array point. For example, a direction of an i^{th} beam formed by the first antenna array is the same as a direction of an i^{th} beam formed by the second antenna array. In addition, a sub-band corresponding to the i^{th} beam formed by the first antenna array is different from a sub-band corresponding to the i^{th} beam formed by the second antenna array. Therefore, from a perspective of a far field, it may be considered that L spatial regions covered by each antenna array are the same as L spatial regions covered by any other antenna array. In other words, a receiving end in each coverage area may receive signals sent by different antenna arrays.

It may be understood that a transmitting end may send signals to a first receiving end by using a part of antenna arrays. For example, the part of antenna arrays include the first antenna array and the second antenna array. For another example, the part of antenna arrays include the first antenna array, the second antenna array, and a third antenna array. For a description of the third antenna array, refer to the descriptions of the first antenna array and the second antenna array. Details are not described herein again. Alternatively, this embodiment of this disclosure is further applicable to all antenna arrays in the transmitting end. For example, the transmitting end may send signals to the first receiving end by using all the antenna arrays (in other words, each antenna array in all the antenna arrays sends a signal to the first receiving end by using one sub-band).

FIG. 7 is a schematic of a scenario of a signal sending method according to an embodiment of this disclosure. As shown in FIG. 7, each antenna array may form three beams, and the three beams correspond to different sub-bands. In addition, a bandwidth scheduled by each antenna array is different from a bandwidth scheduled by any other antenna array. For example, a bandwidth scheduled by a first antenna array (for example, an array 1 shown in FIG. 7) is a bandwidth represented by a number 1 to a number 3. The number 1, a number 2, and the number 3 may respectively represent different sub-bands. For example, a sub-band 1, a sub-band 2, and a sub-band 3 may be adjacent. For example, a center frequency of the sub-band 1 is greater than a center frequency of the sub-band 2, and the center frequency of the sub-band 2 is greater than a center frequency of the sub-band 3. Similarly, for descriptions of a second antenna array (an array 2 shown in FIG. 7), a third antenna array (an array 3 shown in FIG. 7) and a fourth antenna array (an array 4 shown in FIG. 7), refer to the first antenna array. It should be noted that, that the sub-bands shown in this embodiment of this disclosure are adjacent does not mean that the sub-bands are completely contiguous. In consideration of interference between different beams, there may be a guard interval between adjacent sub-bands.

As shown in FIG. 7, directions of beams formed by each antenna array are correspondingly the same as directions of beams formed by any other antenna array. For example, a direction of a beam 1 formed by the first antenna array, a direction of a beam 4 formed by the second antenna array, a direction of a beam 7 formed by the third antenna array, and a direction of a beam 10 formed by a fourth antenna array are the same. For another example, a direction of a beam 2 formed by the first antenna array, a direction of a beam 5 formed by the second antenna array, a direction of a beam 8 formed by the third antenna array, and a direction of a beam 11 formed by the fourth antenna array are the same. For example, a direction of a beam 3 formed by the first antenna array, a direction of a beam 6 formed by the second antenna array, a direction of a beam 9 formed by the third antenna array, and a direction of a beam 12 formed by the fourth antenna array are the same.

Optionally, a bandwidth configured for a UE 1, a UE 2, and a UE 3 may be a bandwidth corresponding to the sub-band 1 to a sub-band 12. For this implementation, although a bandwidth actually used by a receiving end is less than a bandwidth configured for the receiving end, a transmitting end may more flexibly determine a receiving end that can be served by the transmitting end.

Optionally, a bandwidth configured for the UE 1 may be a bandwidth corresponding to the sub-band 1, a sub-band 4, a sub-band 7, and a sub-band 10. A bandwidth configured for the UE 2 may be a bandwidth corresponding to the sub-band 2, a sub-band 5, a sub-band 8, and a sub-band 11. A bandwidth configured for the UE 3 may be a bandwidth corresponding to the sub-band 3, a sub-band 6, a sub-band 9, and the sub-band 12. For this implementation, when a position of the UE is fixed, large-bandwidth communication of the UE can be effectively implemented.

Optionally, a bandwidth configured for the UE 1 may be a sum of a bandwidth corresponding to the sub-band 1, a sub-band 4, a sub-band 7, and a sub-band 10 and a bandwidth corresponding to the sub-band 2, a sub-band 5, a sub-band 8, and a sub-band 11. Alternatively, a bandwidth configured for the UE 1 may be a sum of a bandwidth corresponding to the sub-band 1, a sub-band 4, a sub-band 7, and a sub-band 10 and a bandwidth corresponding to the sub-band 3, a sub-band 6, a sub-band 9, and a sub-band 12. It may be understood that, for descriptions of the UE 2 and the UE 3, refer to the UE 1. Details are not listed herein again. This implementation is more applicable to a case in which a position of the UE moves, so that the receiving end can flexibly schedule the bandwidth.

It may be understood that the descriptions of the bandwidth configured for the UE and the sub-band are also applicable to the following embodiments.

In this embodiment of this disclosure, a bandwidth scheduled by each antenna array is completely independent, in other words, bandwidth ranges of antenna arrays do not overlap (which may also be referred to as that the bandwidth ranges do not intersect). Therefore, sub-bands of the antenna arrays do not overlap either. However, the bandwidth scheduled by each antenna array is included in a bandwidth configured for a first receiving end. In this way, interference between different receiving ends can be effectively alleviated.

In this embodiment of this disclosure, a bandwidth occupied by a signal sent by each antenna array is completely independent. In this case, a receiving end in each coverage area may receive signals sent by different beams, and the different beams correspond to different sub-bands. In other words, receiving ends in L coverage areas each may receive signals corresponding to Z sub-bands (one sub-band in each antenna array). The method shown in this embodiment of this disclosure is easy to implement, and receiving ends in different coverage areas have strong anti-interference capabilities. In this embodiment of this disclosure, the antenna arrays in the transmitting end occupy a total of Z*L sub-bands, and the receiving ends in the L different coverage areas each can implement broadband communication of Z sub-bands. It may be understood that the method shown in FIG. 7 may also be understood as a signal sending method based on an independent bandwidth policy.

### Embodiment 2

A bandwidth scheduled by a first antenna array partially overlaps a bandwidth scheduled by a second antenna array. Alternatively, it may be understood as that a sub-band scheduled by the first antenna array partially overlaps a sub-band scheduled by the second antenna array.

Optionally, directions to which L beams formed by at least two antenna arrays point are correspondingly the same. Optionally, directions to which L beams formed by each antenna array point are correspondingly the same. For specific descriptions of the direction of the beam and a quantity of antenna arrays that send signals to a first receiving end, refer to Embodiment 1. Details are not described herein again.

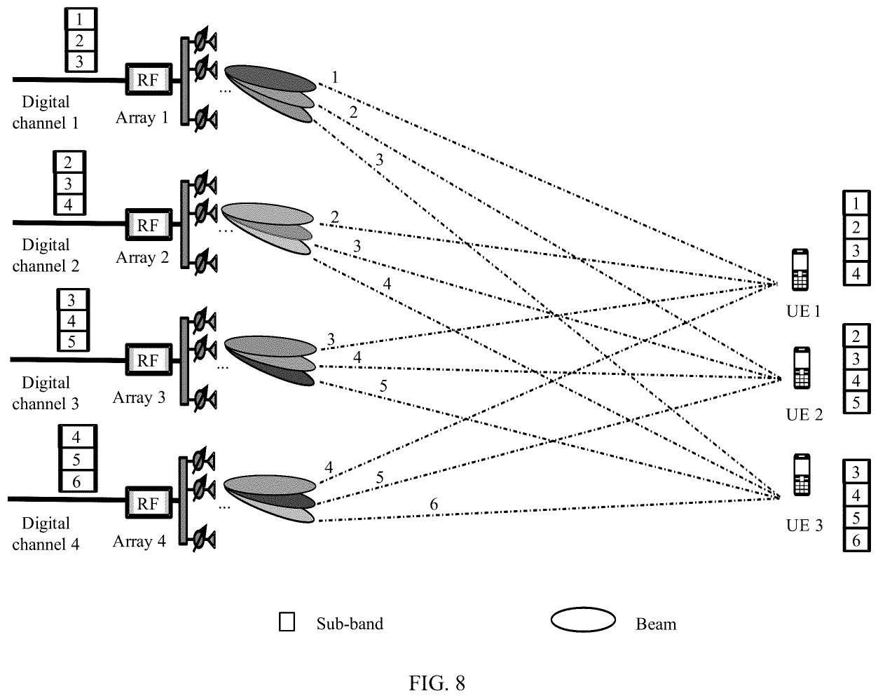

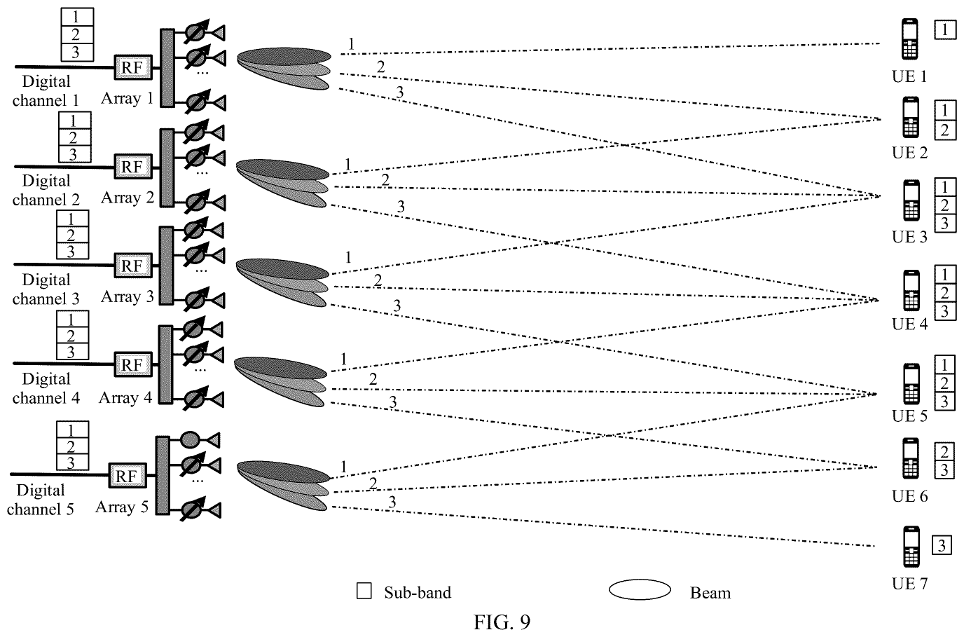

FIG. 8 is a schematic of a scenario of still another signal sending method according to an embodiment of this disclosure. As shown in FIG. 8, each antenna array may form three beams, and the three beams correspond to different sub-bands. In addition, a bandwidth scheduled by each antenna array partially overlaps a bandwidth scheduled by any other antenna array. For example, a bandwidth scheduled by a first antenna array (for example, an array 1 shown in FIG. 8) is a bandwidth represented by a number 1 to a number 3. The number 1, a number 2, and the number 3 may respectively represent different sub-bands, for example, a sub-band 1, a sub-band 2, and a sub-band 3. A bandwidth scheduled by a second antenna array (an array 2 shown in FIG. 8) is a bandwidth corresponding to the sub-band 2 to a sub-band 4. A bandwidth scheduled by a third antenna array (an array 3 shown in FIG. 8) is a bandwidth corresponding to the sub-band 3 to a sub-band 5. A bandwidth scheduled by a fourth antenna array (an array 4 shown in FIG. 8) is a bandwidth corresponding to the sub-band 4 to a sub-band 6.

As shown in FIG. 8, directions of beams formed by all the antenna arrays are correspondingly the same. For example, a direction of a beam 1 formed by the first antenna array, a direction of a beam 2 formed by the second antenna array, a direction of a beam 3 formed by the third antenna array, and a direction of a beam 4 formed by the fourth antenna array are the same. For another example, a direction of a beam 2 formed by the first antenna array, a direction of a beam 3 formed by the second antenna array, a direction of a beam 4 formed by the third antenna array, and a direction of a beam 5 formed by the fourth antenna array are the same. For example, a direction of a beam 3 formed by the first antenna array, a direction of a beam 4 formed by the second antenna array, a direction of a beam 5 formed by the third antenna array, and a direction of a beam 6 formed by the fourth antenna array are the same. It may be understood that for a part that is not described in detail in FIG. 8, refer to FIG. 7 and the like.

In this embodiment of this disclosure, the bandwidths scheduled by all the antenna array partially overlap. For example, a bandwidth (that is, a bandwidth corresponding to L beams) occupied by a signal sent by each antenna array is staggered with a bandwidth occupied by a signal sent by any other antenna array (for example, adjacent antenna arrays multiplex L−1 sub-bands). In addition, in different antenna arrays, same sub-bands correspond to different directions of beams, or beams in a same direction correspond to different sub-bands.

It should be noted that, a quantity of sub-bands multiplexed by adjacent antenna arrays is not limited in embodiments of this disclosure, but the quantity of the multiplexed sub-bands is greater than or equal to 1 and less than L−1.

According to the method provided in this embodiment of this disclosure, signals of the same sub-bands are sent to different receiving ends in a manner of spatial division multiplexing, to effectively save bandwidth resources. From a perspective of spectral efficiency, when a transmitting end sends signals, Z+L−1 sub-bands are occupied, so that it can be ensured that receiving ends in L different coverage areas can implement broadband communication of Z sub-bands. It may be understood that the method shown in FIG. 8 may alternatively be understood as a signal sending method based on staggered bandwidth measurement. In addition, the methods shown in FIG. 7 and FIG. 8 may alternatively be collectively referred to as a signal sending method based on a same coverage and different bandwidths.

For Embodiment 1 and Embodiment 2, the following describes a method for sending a signal by a transmitting end by using an example. For example, for FIG. 7 and FIG. 8, each antenna array has three sub-bands. Therefore, for example, center frequencies of the three sub-bands of a first antenna array (only an example) are respectively represented by f1, f2, and f3, and f1, f2, and f3 sequentially increase or decrease. In this case, an intermediate frequency of the first antenna array is a frequency corresponding to the 2^{nd} sub-band, that is, f2, and a pointing direction of a beam corresponding to the 2^{nd} sub-band is, for example, a region λ Therefore, according to the foregoing description of Formula (4), it can be learned that a phase shift parameter of the first antenna array may satisfy Formula (10):

$$ω ( {φ}_{2} , {f}_{2} ) = {\frac{1}{\sqrt{N}} [ 1 , {e}^{- j \frac{2 π {f}_{2} {d}_{a} sin {φ}_{2}}{c}} , … {e}^{- j \frac{( N - 1 ) 2 π {f}_{2} {d}_{a} sin {φ}_{2}}{c}} ]}^{T} \qquad ( 10 )$$

φ2 is a direction pointing to the region λ For a signal at a frequency of f1, a phase change from the first antenna array to the region 1 (for example, a pointing direction of a beam corresponding to a first sub-band) is represented by a(φ₁, f₁). Therefore, f1 and f2 satisfy formula (11):

$${{A}_{f} ( {φ}_{1} , {f}_{1} ) = \vert {ω ( {φ}_{2} , {f}_{2} )}^{H} a ( φ , {f}_{1} ) {\vert}^{2} = \vert \frac{1}{N} {\sum }_{n = 1}^{N} {e}^{- j ( \frac{2 π {f}_{2} {d}_{a} ( n - 1 )}{c} ) ( \frac{{f}_{1}}{{f}_{2}} sin {φ}_{1} - sin {φ}_{2} )} \vert}^{2} = 1 ⇒ \frac{{f}_{1}}{{f}_{2}} sin {φ}_{1} - sin {φ}_{2} = 0 , ⇒ {f}_{1} = {f}_{2} \frac{sin {φ}_{2}}{sin {φ}_{1}} \qquad ( 11 )$$

φ1 is a direction pointing to a region 1. A relationship between f1 and f3 is similar to that between f1 and f2. In other words, the transmitting end may set the center frequency of each sub-band based on a center frequency of a bandwidth scheduled by the first antenna array. It may be understood that the foregoing examples of Formula (10) and Formula (11) are merely examples, and shall not be construed as a limitation on embodiments of this disclosure.

### Embodiment 3

A bandwidth scheduled by a first antenna array is the same as a bandwidth scheduled by a second antenna array. A direction of an i^{th} beam formed by the first antenna array is different from a direction of an i^{th} beam formed by the second antenna array. i is an integer greater than or equal to 1 and less than or equal to L. In addition, at least one of L beams formed by the first antenna array has a same direction as a corresponding beam in L beams formed by the second antenna array.

FIG. 9 is a schematic of a scenario of still another signal sending method according to an embodiment of this disclosure. As shown in FIG. 9, each antenna array may form three beams, and the three beams correspond to different sub-bands. In addition, a bandwidth scheduled by each antenna array is the same as a bandwidth scheduled by any other antenna array. However, directions of i^{th} beams formed by all the antenna arrays are different. For example, a bandwidth scheduled by a first antenna array (for example, an array 1 shown in FIG. 9) is a bandwidth represented by a number 1 to a number 3. The number 1, a number 2, and the number 3 may respectively represent different sub-bands, for example, a sub-band 1, a sub-band 2, and a sub-band 3. A direction of a beam 1 corresponding to the sub-band 1 points to a region in which a UE 1 is located. A direction of a beam 2 corresponding to the sub-band 2 points to a region in which a UE 2 is located. A direction of a beam 3 corresponding to the sub-band 3 points to a region in which a UE 3 is located. Similarly, for a second antenna array (an array 2 shown in FIG. 9), a direction of a beam 1 corresponding to a sub-band 1 points to the region in which the UE 2 is located, that is, the direction of the beam 1 formed by the first antenna array is different from the direction of the beam 1 formed by the second antenna. It may be understood that for descriptions of the second antenna array, a third antenna array (an array 3 shown in FIG. 9), and a fourth antenna array (an array 4 shown in FIG. 9), refer to the first antenna array. Details are not described herein again.

In this embodiment of this disclosure, each of Z antenna arrays included in a transmitting end may form L beams, and a total of Z+L−1 regions may be covered. The method can cover more regions, to serve more receiving ends, and further save bandwidth resources.

### Embodiment 4

A bandwidth scheduled by a first antenna array is the same as a bandwidth scheduled by a second antenna array. Optionally, bandwidths scheduled by all antenna arrays are the same. A direction of an i^{th} beam formed by the first antenna array is different from a direction of an i^{th} beam formed by the second antenna array. i is an integer greater than or equal to 1 and less than or equal to L. In addition, directions of L beams formed by the first antenna array are completely different from directions of L beams formed by the second antenna array.

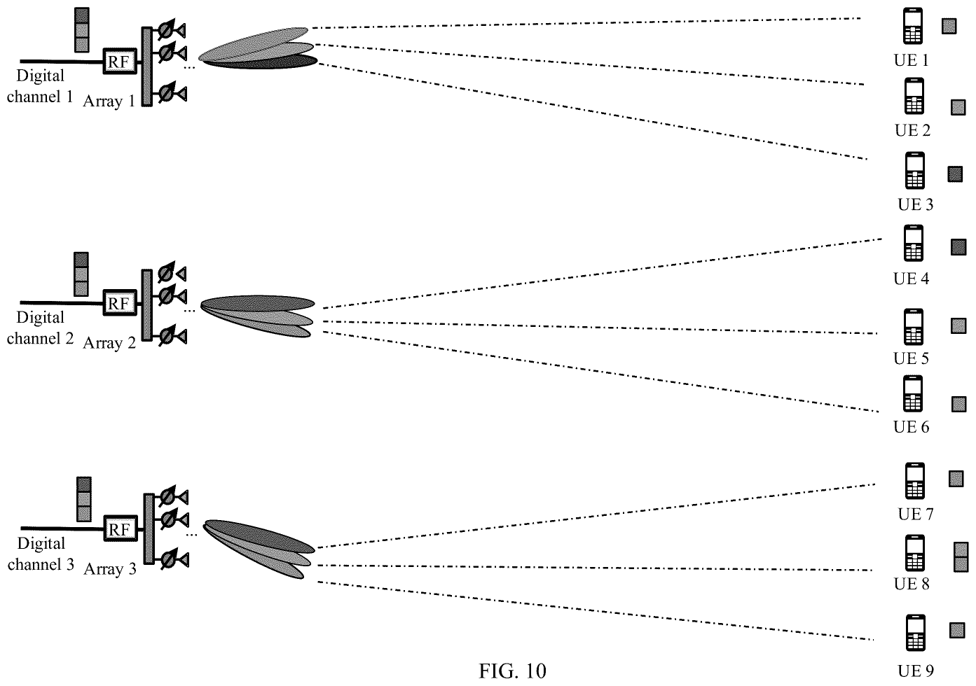

FIG. 10 is a schematic of a scenario of still another signal sending method according to an embodiment of this disclosure. As shown in FIG. 10, each antenna array may form three beams, and the three beams correspond to different sub-bands. In addition, bandwidths scheduled by all antenna arrays are the same. However, directions of beams formed by a first antenna array are completely different from directions of beams formed by a second antenna array (also including a case in which the beams do not overlap at all). For example, the directions of the beams formed by the first antenna array (for example, an array 1 shown in FIG. 10) point to a region in which a UE 1 is located, a region in which a UE 2 is located, and a region in which a UE 3 is located. The directions of the beams formed by the second antenna array (for example, an array 2 shown in FIG. 10) point to a region in which a UE 4 is located, a region in which a UE 5 is located, and a region in which a UE 6 is located. Directions of beams formed by a third antenna array (for example, an array 3 shown in FIG. 10) point to a region in which a UE 7 is located, a region in which a UE 8 is located, and a region in which a UE 9 is located. It may be understood that for a specific description of FIG. 10, refer to the foregoing description. Details are not described herein again.

It may be understood that the methods shown in FIG. 9 and FIG. 10 may also be referred to as a signal sending method based on a same bandwidth and different coverage areas. It may be understood that, for the methods shown in FIG. 9 and FIG. 10, the bandwidth scheduled by each antenna array is the same as the bandwidth scheduled by any other antenna array, and the bandwidth scheduled by the antenna array may be a system bandwidth. Therefore, sub-band division may be more flexibly performed by a transmitting end, to send a signal by using a beam corresponding to each sub-band.

For Embodiment 3 and Embodiment 4, the following describes a method for sending a signal by a transmitting end by using an example. For example, FIG. 9 is used as an example. Center frequencies of three sub-bands of a first antenna array are respectively represented by f1, f2, and f3, and the three center frequencies belong to an interval of [fmin, fmax] (that is, a bandwidth configured for a receiving end). It should be noted that f1, f2, and f3 of different antenna arrays may not be completely the same, but all belong to the interval of [fmin, fmax], and may be considered to be the same as long as corresponding frequencies do not differ greatly. For an array 1, a phase shift coefficient that points to a region 1 and that is obtained based on f1 satisfies Formula (12):

$$ω ( {φ}_{1} , {f}_{1} ) = {\frac{1}{\sqrt{N}} [ 1 , {e}^{- j \frac{2 π {f}_{1} {d}_{a} sin {φ}_{1}}{c}} , … , {e}^{- j \frac{( N - 1 ) 2 π {f}_{1} {d}_{a} sin {φ}_{1}}{c}} ]}^{T} \qquad ( 12 )$$

φ1 is a direction pointing to the region 1. If it is expected that a direction of a beam corresponding to a sub-band f2 can point to a region 2, f1 and f2 satisfy Formula (13):

$${A}_{f} ( {φ}_{2} , {f}_{2} ) = {\vert {ω ( {φ}_{1} , {f}_{1} )}^{H} a ( {φ}_{2} , {f}_{2} ) \vert}^{2} = {\vert \frac{1}{N} {\sum }_{n = 1}^{N} {e}^{- j ( \frac{2 π {f}_{1} {d}_{a} ( n - 1 )}{c} ) ( \frac{{f}_{2}}{{f}_{1}} sin {φ}_{2} - sin φ )} \vert}^{2} = 1 , ⇒ \frac{{f}_{2}}{{f}_{1}} sin {φ}_{2} - sin {φ}_{1} = 0 , ⇒ {f}_{2} = {f}_{1} \frac{sin {φ}_{1}}{sin {φ}_{2}} \qquad ( 13 )$$

Similarly, according to the method shown in Formula (13), a direction of a beam corresponding to f3 of the first antenna array may also be enabled to point to a region 3. For a second antenna array, f1 of the second antenna array may also be enabled to point to the region 2 by using the same method. By analogy, it can be ensured that a beam corresponding to each sub-band can point to a corresponding region.

In this embodiment of this disclosure, each of Z antenna arrays included in the transmitting end may form L beams, and a total of Z*L regions may be covered. The method can cover more regions, to serve more receiving ends, and further save bandwidth resources.

It should be noted that the frequency shown above in this disclosure may be represented by f, or may be represented by italic f. For example, a parameter such as a frequency or an angle in the foregoing formula is represented in italics, such as f and φ. In other words, a specific representation form of the parameter is not limited in embodiments of this disclosure.

It may be understood that when a system-configured bandwidth is large enough, the same-coverage different-bandwidth signal sending method shown in embodiments of this disclosure may be used. When the system-configured bandwidth is not large enough, the same-bandwidth different-coverage signal sending method shown in embodiments of this disclosure may be used.

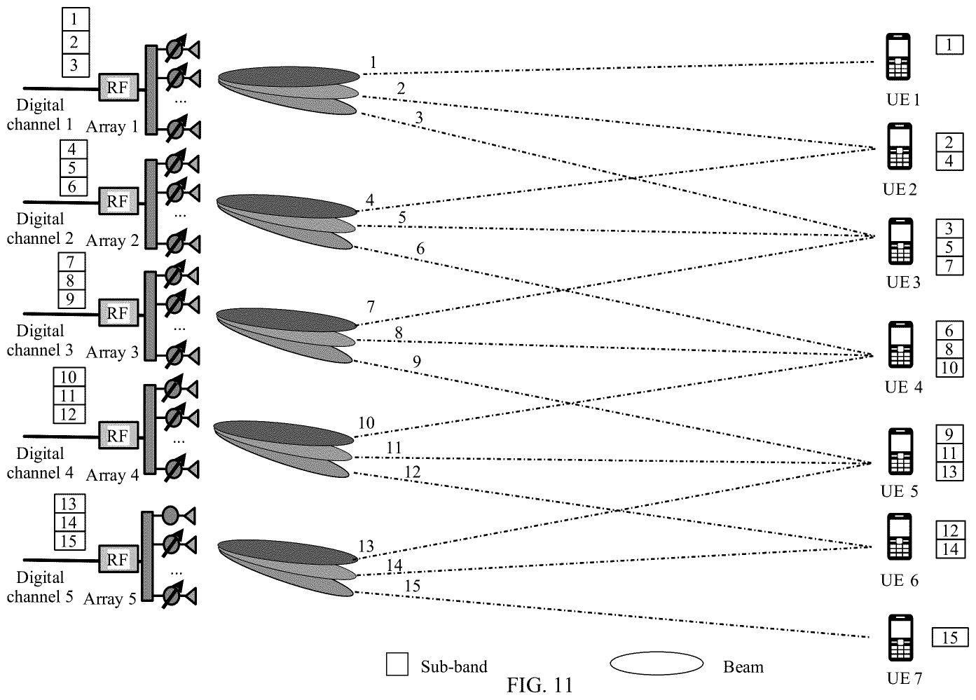

It may be understood that in each of the foregoing embodiments, for an implementation that is not described in detail in one embodiment, refer to another embodiment. Details are not described herein again. For example, with reference to the foregoing embodiments, FIG. 11 is a schematic of a scenario of still another signal sending method according to an embodiment of this disclosure. As shown in FIG. 11, each antenna array may form three beams, and the three beams correspond to different sub-bands. In addition, bandwidths scheduled by all antenna arrays are different. Directions of beams formed by at least two antenna arrays in a transmitting end partially overlap, and/or directions of beams formed by at least two antenna arrays in a transmitting end do not overlap. For example, directions of beams formed by a first antenna array (for example, an array 1 shown in FIG. 11) point to a region in which a UE 1 is located, a region in which a UE 2 is located, and a region in which a UE 3 is located. Directions of beams formed by a second antenna array (for example, an array 2 shown in FIG. 11) point to the region in which the UE 2 is located, the region in which the UE 3 is located, and a region in which a UE 4 is located. Directions of beams formed by a third antenna array (for example, an array 3 shown in FIG. 11) point to the region in which the UE 3 is located, the region in which the U 4 is located, and a region in which a UE 5 is located. Details are not listed herein again.

It should be noted that, the accompanying drawings in embodiments of this disclosure are shown by using an example in which the array 1 is the first antenna array, and the array 2 is the second antenna array. During specific implementation, specific positions of the first antenna array and the second antenna array are not limited in embodiments of this disclosure.

Under an architecture of a large-array phased array, impact of beam squint is used. A method in which different sub-bands of different antenna arrays can be scheduled to a same region is added. A purpose of large-bandwidth communication of an effective bandwidth of a receiving end in this region is implemented. Combination with spatial division multiplexing effectively improves spectral efficiency of a system. In addition, according to the method provided in embodiments of this disclosure, different sub-bands of different antenna arrays may further point to different regions, to improve a coverage area of the system. Especially, in some cases, for example, a case in which beam scanning is required, user access time can be effectively reduced. For example, beam scanning means that a beam is scanned in the coverage area of the system. According to the method provided in embodiments of this disclosure, each antenna array may form a plurality of beams, to increase a coverage area of a single antenna array at a same moment. Frequency division multiplexing increases the coverage area of the antenna array, and reduces scanning time.

In addition, for future communication or the Internet of everything, a communication apparatus (for example, including a transmitting end and/or a receiving end) has a higher requirement on a system rate, and therefore, a system bandwidth is also increased. In addition, because a high frequency has a large bandwidth that can be used, using the high frequency is a trend of a future spectrum. In addition, to resolve a problem of large propagation attenuation of a high-frequency signal, it is an inevitable choice to send signals by using a plurality of antenna arrays. Therefore, according to the method provided in embodiments of this disclosure, large-bandwidth communication of the communication apparatus can be effectively implemented by effectively using beam squint.

A communication apparatus provided in embodiments of this disclosure is described in the following.

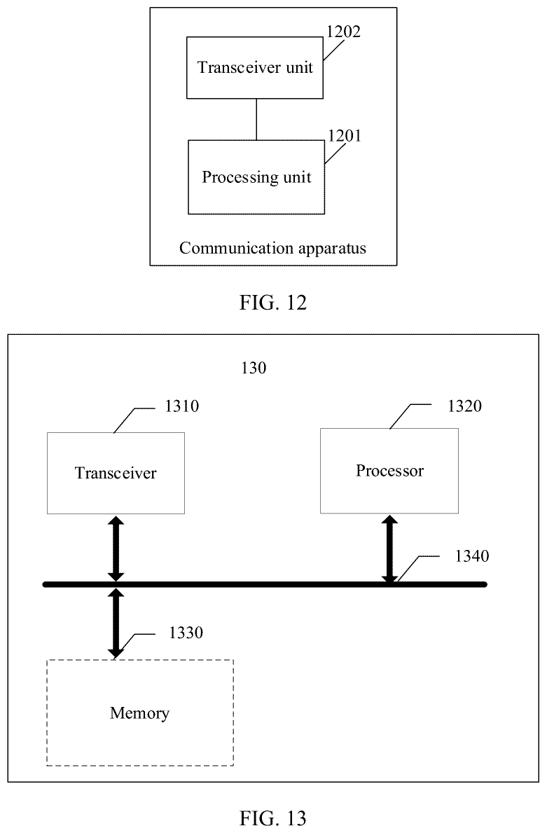

In this disclosure, the communication apparatus is divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that, division of modules in this disclosure is merely an example, and is only division of logical functions. Other division manners may be available in actual implementations. The following describes in detail the communication apparatus in embodiments of this disclosure with reference to FIG. 12 to FIG. 14.

FIG. 12 is a schematic of a structure of a communication apparatus according to an embodiment of this disclosure. As shown in FIG. 12, the communication apparatus includes a processing unit 1201 and a transceiver unit 1202.

The communication apparatus may be the transmitting end shown above, a chip in the transmitting end, or the like. In other words, the communication apparatus may be configured to perform steps, functions, or the like performed by the transmitting end in the method embodiments.

For example, the processing unit 1201 is configured to obtain at least two first signals through a first channel.

The transceiver unit 1202 is configured to send the at least two first signals to at least two receiving ends based on a first antenna array.

Optionally, the transceiver unit 1202 is specifically configured to send, to a first receiving end by using at least two antenna arrays, at least two signals corresponding to the first receiving end.

Optionally, the transceiver unit 1202 is specifically configured to send, to a second receiving end by using at least two antenna arrays, at least two signals corresponding to the second receiving end.

Optionally, the transceiver unit 1202 is specifically configured to: send, to the first receiving end by using the at least two antenna arrays, the at least two signals corresponding to the first receiving end; and send the first signal to the second receiving end by using the first antenna array.

Optionally, the transceiver unit 1202 is specifically configured to: send, to the first receiving end by using the at least two antenna arrays, the at least two signals corresponding to the first receiving end; and send, to the second receiving end by using the at least two antenna arrays, the at least two signals corresponding to the second receiving end.

For example, the processing unit 1201 is configured to obtain the at least two signals through at least two channels. One channel corresponds to one signal.

The transceiver unit 1202 is configured to send the at least two signals to the first receiving end based on the at least two antenna arrays.

In this embodiment of this disclosure, for descriptions of the first channel, a sub-band, the first antenna array, the receiving end, the first receiving end, and the like, refer to the descriptions in the foregoing method embodiments (including FIG. 4 to FIG. 11). Details are not described herein again.

It may be understood that specific descriptions of the transceiver unit and the processing unit shown in this embodiment of this disclosure are merely examples. For specific functions of the transceiver unit and the processing unit, steps performed by the transceiver unit and the processing unit, or the like, refer to the foregoing method embodiments. Details are not described herein again.

The foregoing describes the transmitting end in this embodiment of this disclosure, and the following describes an example product form of the transmitting end. It should be understood that any form of product having the functions of the transmitting end shown in FIG. 12 falls within the protection scope of embodiments of this disclosure. It should be further understood that the following description is merely an example, and does not constitute a limitation on the product form of the transmitting end in this embodiment of this disclosure.

In an example implementation, in the communication apparatus shown in FIG. 12, the processing unit 1201 may be one or more processors. The transceiver unit 1202 may be a transceiver, or the transceiver unit 1202 may be a sending unit and a receiving unit. The sending unit may be a transmitter, the receiving unit may be a receiver, and the sending unit and the receiving unit are integrated in one device, such as the transceiver. In this embodiment of this disclosure, the processor and the transceiver may be coupled, or the like. A connection manner between the processor and the transceiver is not limited in embodiments of this disclosure.

As shown in FIG. 13, a communication apparatus 130 includes one or more processors 1320 and a transceiver 1310.

For example, when the communication apparatus is configured to perform the steps, the methods, or the functions performed by the foregoing transmitting end, the processor 1320 is configured to obtain at least two first signals through a first channel, and the transceiver 1310 is configured to send the at least two first signals.

Optionally, the transceiver 1310 is specifically configured to send, to a second receiving end by using the at least two antenna arrays, at least two signals corresponding to the second receiving end.

Optionally, the transceiver 1310 is specifically configured to: send, to a first receiving end by using at least two antenna arrays, at least two signals corresponding to the first receiving end; and send the first signal to the second receiving end by using a first antenna array.

Optionally, the transceiver 1310 is specifically configured to: send, to the first receiving end by using the at least two antenna arrays, the at least two signals corresponding to the first receiving end; and send, to the second receiving end by using the at least two antenna arrays, the at least two signals corresponding to the second receiving end.

For example, the processor 1320 is configured to obtain the at least two signals through at least two channels. One channel corresponds to one signal.

The transceiver 1310 is configured to send the at least two signals to the first receiving end based on the at least two antenna arrays.

It may be understood that for specific descriptions of the processor and the transceiver, refer to the descriptions of the processing unit and the transceiver unit shown in FIG. 12. Details are not described herein again. Alternatively, for specific descriptions of the processor and the transceiver, refer to the foregoing method embodiments.

In various implementations of the communication apparatus shown in FIG. 13, the transceiver may include a receiver and a transmitter. The receiver is configured to perform a receiving function (or operation), and the transmitter is configured to perform a transmitting function (or operation). In addition, the transceiver is configured to communicate with another device or apparatus through a transmission medium.

Optionally, the communication apparatus 130 may further include one or more memories 1330 (represented by dashed lines in FIG. 13) configured to store program instructions and/or data. The memory 1330 is coupled to the processor 1320. The coupling in this embodiment of this disclosure may be an indirect coupling or a communication connection between apparatuses, units, or modules in an electrical form, a mechanical form, or another form, and is used for information exchange between the apparatuses, the units, or the modules. The processor 1320 may cooperate with the memory 1330. The processor 1320 may execute the program instructions stored in the memory 1330.

A specific connection medium between the transceiver 1310, the processor 1320, and the memory 1330 is not limited in embodiments of this disclosure. In this embodiment of this disclosure, in FIG. 13, the memory 1330, the processor 1320, and the transceiver 1310 are connected through a bus 1340. The bus is represented by a bold line in FIG. 13. A connection manner between other components is merely an example for description, and shall not be construed as a limitation. The bus may be classified into an address bus, a data bus, a control bus, and the like. For ease of representation, only one bold line represents the bus in FIG. 13, but this does not mean that there is only one bus or only one type of bus.

In this embodiment of this disclosure, the processor may be a general purpose processor, a digital signal processor, an disclosure-specific integrated circuit, a field programmable gate array or another programmable logic device, a discrete gate or transistor logic device, a discrete hardware component, or the like. The processor can implement or execute the methods, the steps, and the logical block diagrams disclosed in embodiments of this disclosure. The general purpose processor may be a microprocessor, any conventional processor, or the like. The steps of the methods disclosed in combination with embodiments of this disclosure may be directly implemented by a hardware processor, or may be implemented by using a combination of hardware and software modules in the processor, or the like.

In embodiments of this disclosure, the memory may include but is not limited to a non-volatile memory such as a hard disk drive (HDD) or a solid-state drive (SSD), a random access memory (RAM), an erasable programmable read-only memory (EPROM), a read-only memory (ROM), a compact disc read-only memory (CD-ROM), or the like. The memory is, but not limited to, any storage medium that can be used to carry or store program code in a form of instructions or data structures and that can be read or written by a computer (such as the communication apparatus illustrated in this disclosure). The memory in embodiments of this disclosure may also be a circuit or any other apparatus capable of implementing a storage function, and is configured to store program instructions and/or data.

The processor 1320 is mainly configured to: process a communication protocol and communication data, control the entire communication apparatus, execute a software program, and process data of the software program. The memory 1330 is mainly configured to store the software program and data. The transceiver 1310 may include a control circuit and an antenna. The control circuit is mainly configured to perform conversion between a baseband signal and a radio frequency signal, and process the radio frequency signal. The antenna is mainly configured to receive and send a radio frequency signal in a form of electromagnetic wave. An input/output apparatus, such as a touchscreen, a display, or a keyboard, is mainly configured to receive data input by a user and output data to the user.

After the communication apparatus is powered on, the processor 1320 may read the software program in the memory 1330, interpret and execute instructions of the software program, and process the data of the software program. When data needs to be sent wirelessly, the processor 1320 performs baseband processing on the to-be-sent data, and then outputs a baseband signal to a radio frequency circuit. The radio frequency circuit performs radio frequency processing on the baseband signal, and then sends a radio frequency signal in a form of electromagnetic wave by using the antenna. When the data is sent to the communication apparatus, the radio frequency circuit receives the radio frequency signal by using the antenna, converts the radio frequency signal into a baseband signal, and outputs the baseband signal to the processor 1320. The processor 1320 converts the baseband signal into data, and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

It may be understood that the communication apparatus shown in this embodiment of this disclosure may further have more components and the like than those shown in FIG. 13. This is not limited in embodiments of this disclosure. The foregoing method performed by the processor and the transceiver is merely an example. For specific steps performed by the processor and the transceiver, refer to the method described above.

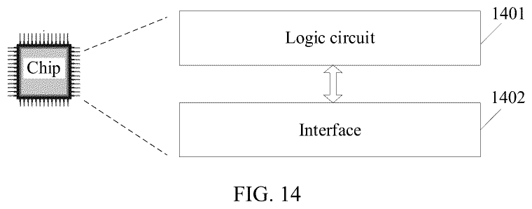

In another example implementation, in the communication apparatus shown in FIG. 12, the processing unit 1201 may be one or more logic circuits, and the transceiver unit 1202 may be an input/output interface, or referred to as a communication interface, an interface circuit, an interface, or the like. Alternatively, the transceiver unit 1202 may be a sending unit and a receiving unit. The sending unit may be an output interface, the receiving unit may be an input interface, and the sending unit and the receiving unit are integrated in one unit, such as the input/output interface. As shown in FIG. 14, a communication apparatus shown in FIG. 14 includes a logic circuit 1401 and an interface 1402. That is, the foregoing processing unit 1201 may be implemented by using the logic circuit 1401, and the transceiver unit 1202 may be implemented by using the interface 1402. The logic circuit 1401 may be a chip, a processing circuit, an integrated circuit, a system on a chip (SoC) chip, or the like. The interface 1402 may be a communication interface, an input/output interface, or the like. For example, in FIG. 14, an example in which the communication apparatus is a chip is used, and the chip includes the logic circuit 1401 and the interface 1402.

In this embodiment of this disclosure, the logic circuit and the interface may also be coupled to each other. A specific connection manner between the logic circuit and the interface is not limited in this embodiment of this disclosure.

For example, when the communication apparatus is configured to perform the methods, the functions, or the steps performed by the foregoing transmitting end, the logic circuit 1401 is configured to obtain at least two first signals through a first channel, and the interface 1402 is configured to output the at least two first signals to at least two receiving ends based on a first antenna array.

It may be understood that, in this embodiment of this disclosure, that the interface 1402 is configured to output the at least two first signals to at least two receiving ends based on a first antenna array may alternatively be understood as that the logic circuit 1401 and the control interface 1402 output the at least two first signals. The descriptions of the interface and the logic circuit are also applicable to the following descriptions.

Optionally, the interface 1402 is specifically configured to send, to a second receiving end by using at least two antenna arrays, at least two signals corresponding to the second receiving end.

Optionally, the interface 1402 is specifically configured to: send, to a first receiving end by using at least two antenna arrays, at least two signals corresponding to the first receiving end; and send the first signal to the second receiving end by using a first antenna array.

Optionally, the interface 1402 is specifically configured to: send, to the first receiving end by using the at least two antenna arrays, the at least two signals corresponding to the first receiving end; and send, to the second receiving end by using the at least two antenna arrays, the at least two signals corresponding to the second receiving end.

For example, the logic circuit 1401 is configured to obtain the at least two signals through at least two channels. One channel corresponds to one signal.

The interface 1402 is configured to send the at least two signals to the first receiving end based on the at least two antenna arrays.

It may be understood that specific descriptions of the logic circuit and the interface shown in embodiments of this disclosure are merely examples. For specific functions of the logic circuit and the interface, steps performed by the logic circuit and the interface, or the like, refer to the foregoing method embodiments, the communication apparatus shown in FIG. 12 or FIG. 13, and the like. Details are not described herein again.

It may be understood that the communication apparatus shown in embodiments of this disclosure may implement the method provided in embodiments of this disclosure in a form of hardware, or may implement the method provided in embodiments of this disclosure in a form of software. This is not limited in embodiments of this disclosure.

In addition, this disclosure further provides a computer program. The computer program is used to implement operations and/or processing performed by a transmitting end in the method provided in this disclosure.

This disclosure further provides a computer-readable storage medium. The computer-readable storage medium stores computer code. When the computer code is run on a computer, the computer is enabled to perform operations and/or processing performed by a transmitting end in the method provided in this disclosure.

This disclosure further provides a computer program product. The computer program product includes computer code or a computer program. When the computer code or the computer program is run on a computer, operations and/or processing performed by a transmitting end in the method provided in this disclosure are/is performed.

In several embodiments provided in this disclosure, it should be understood that the disclosed system, apparatus, and method may be implemented in other manners. For example, the described apparatus embodiments are merely examples. For example, division into the units is merely logical function division. During actual implementation, there may be another division manner. For example, a plurality of units or components may be combined or integrated into another system, or some features may be ignored or not performed. In addition, the displayed or discussed mutual couplings or direct couplings or communication connections may be indirect couplings or communication connections through some interfaces, apparatuses or units, or may be electrical connections, mechanical connections, or connections in other forms.

The units described as separate parts may or may not be physically separate, and parts displayed as units may or may not be physical units, may be in one position, or may be distributed on a plurality of network units. Some or all of the units may be selected based on actual needs to achieve the technical effects of the solutions provided in embodiments of this disclosure.

In addition, functional units in embodiments of this disclosure may be integrated into one processing unit, or each of the units may exist alone physically, or two or more units may be integrated into one unit. The integrated unit may be implemented in a form of hardware, or may be implemented in a form of software functional unit.

When the integrated unit is implemented in the form of software functional unit and sold or used as an independent product, the integrated unit may be stored in a computer-readable storage medium. Based on such an understanding, the technical solutions of this disclosure essentially, or the part contributing to a conventional technology, or all or some of the technical solutions may be implemented in a form of software product. The computer software product is stored in a readable storage medium and includes several instructions for instructing a computer device (which may be a personal computer, a server, a network device, or the like) to perform all or some of the steps of the methods described in embodiments of this disclosure. The readable storage medium includes any medium that can store program code, such as a USB flash drive, a removable hard disk, a read-only memory (ROM), a random access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A method, wherein the method is applied to a transmitting end and the method comprises:
obtaining at least two signals through a first channel; and
sending the at least two signals to a first receiving end and a second receiving end using a first antenna array, wherein a first signal of the at least two signals is sent to the first receiving end, a second signal of the at least two signals is sent to the second receiving end, sub-bands carrying each of the at least two first signals are different, the first signal is on a first beam, the second signal is on a second beam, a first direction of the first beam is different from a second direction of the second beam, and the first beam and the second beam are formed by the first antenna array.

2. The method according to claim 1, further comprising:
sending, to the first receiving end using a second antenna array, a third signal wherein a third sub-band carrying the third signal is different from a first sub-band carrying the first signal.

3. The method according to claim 2, where a direction of an i^{th} beam formed by the first antenna array is the same as a direction of an i^{th} beam formed by the second antenna array, i is an integer greater than or equal to 1 and less than or equal to L, L is a quantity of beams formed by the first antenna array, and the i^{th} beams formed by the first and second arrays carry signals to a same i^{th} receiving end.

4. The method according to claim 3, where a sub-band corresponding to the i^{th} beam formed by the first antenna array is different from a sub-band corresponding to the i^{th} beam formed by the second antenna array.

5. The method according to claim 2, where the direction of the i^{th} beam formed by the first antenna array is different from the direction of the i^{th} beam formed by the second antenna array, i is an integer greater than or equal to 1 and less than or equal to L, Lis the quantity of beams formed by the first antenna array or the quantity of beams formed by the second antenna array, and the i^{th} beams formed by the first and second arrays carry signals to a same i^{th} receiving end.

6. The method according to claim 2, where
a bandwidth scheduled by the first antenna array is the same as a bandwidth scheduled by the second antenna array; or
a bandwidth scheduled by the first antenna array is different from a bandwidth scheduled by the second antenna array; or
a bandwidth scheduled by the first antenna array partially overlaps a bandwidth scheduled by the second antenna array.

7. A method, where the method is applied to a transmitting end and the method comprises:
obtaining a first signal through a first channel, and obtaining a second signal through a second channel; and
sending the first signal to a first receiving end using the first antenna array, and sending the second signal to the first receiving end using the second antenna array; wherein a first sub-band carrying the first signal is different from a second sub-band carrying the second signal, and a first direction of a first beam that is formed by the first antenna array and that carries the first signal is the same as a second direction of a second beam that is formed by the second antenna array and that carries the second signal.

8. The method according to claim 7, where a first quantity of sub-bands corresponding to the first antenna array is the same as a second quantity of sub-bands corresponding to the second antenna array.

9. The method according to claim 7, where a third quantity of beams formed by the first antenna array is different from a fourth quantity of beams formed by the second antenna array.

10. The method according to claim 7, where the first channel is a digital channel between a baseband digital port and a radio frequency link.

11. An apparatus comprising:
one or more processors; and
a non-transitory computer-readable storage medium coupled to the one or more processors and storing programming for execution by the processors, wherein the programming, when executed by the one or more processors, configures the video encoding device to carry out operations comprising:
obtaining at least two signals through a first channel; and
sending the at least two signals to a first receiving end and a second receiving end using the first antenna array, wherein a first signal of the at least two signals is sent to the first receiving end, a second signal of the at least two signals is sent to the second receiving end, sub-bands carrying each of the at least two first signals are different, the first signal is on a first beam, the second signal is on a second beam, a first direction of the first beam is different from a second direction of the second beam, and the first beam and the second beam are formed by the first antenna array.

12. The apparatus according to claim 11, where to the operations further comprise:
sending, to the first receiving end using a second antenna array, a third signal, wherein a third sub-band carrying the third signal is different from a first sub-band carrying the first signal.

13. The apparatus according to claim 12, where a direction of an i^{th} beam formed by the first antenna array is the same as a direction of an i^{th} beam formed by the second antenna array, i is an integer greater than or equal to 1 and less than or equal to L, L is a quantity of beams formed by the first antenna array, and the i^{th} beams formed by the first and second arrays carry signals to a same i^{th} receiving end.

14. The apparatus according to claim 13, where a sub-band corresponding to the i^{th} beam formed by the first antenna array is different from a sub-band corresponding to the i^{th} beam formed by the second antenna array.

15. The apparatus according to claim 12, where the direction of the i^{th} beam formed by the first antenna array is different from the direction of the i^{th} beam formed by the second antenna array, i is an integer greater than or equal to 1 and less than or equal to L, L is the quantity of beams formed by the first antenna array or the quantity of beams formed by the second antenna array, and the i^{th} beams formed by the first and second arrays carry signals to a same i^{th} receiving end.

16. The apparatus according to claim 12, where
a bandwidth scheduled by the first antenna array is the same as a bandwidth scheduled by the second antenna array; or
a bandwidth scheduled by the first antenna array is different from a bandwidth scheduled by the second antenna array; or
a bandwidth scheduled by the first antenna array partially overlaps a bandwidth scheduled by the second antenna array.

17. A non-transitory computer-readable storage medium, wherein the computer-readable storage medium is configured to store a computer program; and when the computer program is executed it causes a corresponding device to:
obtain a first signal through a first channel, and obtain a second signal through a second channel; and
send the first signal to a first receiving end using a first antenna array, and send the second signal to the first receiving end using a second antenna array; wherein a first sub-band carrying the first signal is different from a second sub-band carrying the second signal, and a first direction of a first beam that is formed by the first antenna array and that carries the first signal is the same as a second direction of a second beam that is formed by the second antenna array and that carries the second signal.

18. The non-transitory computer-readable storage medium according to claim 17, where a first quantity of sub-bands corresponding to the first antenna array is the same as a second quantity of sub-bands corresponding to the second antenna array.

19. The non-transitory computer-readable storage medium according to claim 17, where a third quantity of beams formed by the first antenna array is different from a fourth quantity of beams formed by the second antenna array.

20. The non-transitory computer-readable storage medium according to claim 17, where the first channel is a digital channel between a baseband digital port and a radio frequency link.
